(19) United States
(12) Patent Application Publication
(10) Pub. No.: US 2022/0051229 A1
(43) Pub. Date: Feb. 17, 2022

(54) METHOD FOR MANAGEMENT OF VALUE DATA STORED BY OR ON BEHALF OF A USER

(71) Applicant: Peter Garrett, Mill Valley, CA (US)

(72) Inventor: Peter Garrett, Mill Valley, CA (US)

(21) Appl. No.: 17/125,752

(22) Filed: Dec. 17, 2020

Related U.S. Application Data
(63) Continuation-in-part of application No. 16/991,934, filed on Aug. 12, 2020.
Application No. 16/991,934 is a continuation-in-part of application No. 16/997,746, filed on Aug. 19, 2020.
Application No. 16/997,746 is a continuation-in-part of application No. 17/104,922, filed on Nov. 25, 2020.
Application No. 17/104,922 is a continuation-in-part of application No. 17/062,580, filed on Oct. 3, 2020.
Application No. 17/062,580 is a continuation-in-part of application No. 17/062,574, filed on Oct. 3, 2020.
Application No. 17/062,574 is a continuation-in-part of application No. 17/013,591, filed on Sep. 5, 2020.
Application No. 17/013,591 is a continuation-in-part of application No. 16/997,746, filed on Aug. 19, 2020.
Application No. 16/997,746 is a continuation-in-part of application No. 16/991,934, filed on Aug. 12, 2020.

(51) Int. Cl. G06Q 20/36; G06Q 20/32; G06Q 20/04

(52) U.S. Cl. CPC G06Q 20/36; G06Q 20/047; G06Q 20/3224; G06Q 20/3274

(57) ABSTRACT

A method is provided for acquisition and management of value codes available to a client including (a) capturing to a network-capable computing device one or more value codes directed to a client through consumer activity, (b) acquiring over the network the value codes captured in (a), (c) isolating the value codes acquired in (b) and storing the value codes on behalf of the client, (d) monitoring the location of, consumer activity of, and data generated by the client comparing results against client value data content matching content relevancy, (e) upon determination of content relevancy, selecting value codes and generating a notification for the client identifying the value codes available to the client for use, and (f) sending the notification to the client over the network, the notification containing the value codes, or at least providing immediate access to the value codes selected for consideration by the client.

### CROSS-REFERENCE TO RELATED DOCUMENTS

The present invention claims priority as a CIP to U.S. patent application Ser. No. 17/104,922, entitled “METHODS FOR REMOTE TRANSACTION RECEIPT CAPTURE BASED ON EVIDENCE OF A TRANSACTION IN PROGRESS”, filed on Nov. 25, 2020. The instant application also claims priority as a CIP to U.S. patent application Ser. No. 17/062,580 entitled “METHOD FOR TRANSFER AND AGGREGATION OF ELECTRONIC RECEIPTS” filed on Oct. 3, 2020. The instant application also claims priority as a CIP to U.S. patent application Ser. No. 17/062,574 entitled “RECEIPT AGGREGATION MODEL” filed on Oct. 3, 2020. The instant application also claims priority as a CIP to U.S. patent application Ser. No. 17/013,591 entitled “METHOD FOR VOICE TAGGING AN ELECTRONIC RECEIPT ACQUIRED AFTER A TRANSACTION” filed on Sep. 5, 2020. The instant application also claims priority as a CIP to U.S. patent application Ser. No. 16/997,746 entitled “METHOD OF ELECTRONIC RECEIPT CAPTURE FOR REAL-TIME TRANSACTED EXPENDITURES” filed on Aug. 19, 2020. The instant application also claims priority as a CIP to U.S. patent application Ser. No. 16/991,934 entitled “FLAG SYSTEM AND METHOD OF FLAGGING FOR REAL-TIME EXPENDITURES TRANSACTED ELECTRONICALLY” filed on Aug. 12, 2020. All of the disclosures mentioned above are included herein at least by reference.

### BACKGROUND OF THE INVENTION

### 1. Field of the Invention

The present invention is in the field of financial transacting including over a network and pertains particularly to methods and apparatus for digitally managing value data including QR code data aggregated and archived by or on behalf of a user.

### 2. Discussion of the State of the Art

Payment cards are part of a payment system used by financial institutions like banks, for example, to enable cardholders to access funds held in designated bank accounts or credit accounts. The cardholder may make payments by electronic funds transfer (EFT) and access automated teller machines (ATM's). There are several types of payment cards in the art, perhaps the most common classes being credit cards and debit cards.

A more recent type of payment card existing in the art is generally termed a smart card in the art. Smart cards are payment cards that contain a unique card number and some security information such as an expiration date or card verification value (CVV) and a magnetic strip and an embedded euro-pay master card and visa (EMV) chip (secure element) enabling various machines (transaction point terminals) like point of sale (POS) machines to read and access information from the card.

More recently, smart cards have been adapted as mobile dynamic smart transaction cards. A dynamic smart card may have multiple payment card data dynamically loaded onto the single form factor of the card. A user may add any or all payment card data from debit, credit, and loyalty accounts to a mobile application associated with the smart card, such as into a cloud wallet application. The user may load the data onto the smart card via Bluetooth wireless technology or any other wireless technology.

All-in-one smart cards are referred to in the field as dynamic smart cards. An owner of a dynamic smart card may load multiple payment account data sets onto a single payment card form factor. A user may add payment card data sets for debit, credit, gift, and loyalty to the dynamic smart card. For example, the user may leverage a mobile phone application (executed on phone) such as a mobile wallet application associated with the dynamic smart card to authenticate (identity, confirm) and move the payment card data sets onto the dynamic smart card over a Bluetooth™ or other wireless network connection between the user's smart phone and the dynamic smart card before the card is used in a transaction.

One important aspect of an expenditure is whether or not the expenditure or part of the expenditure may be a tax deduction. In general practice some applications like bank card applications tied to banks may enable a user working in the application to browse expenditure items by category and item specifics for the purpose of assigning items as tax-deductible expenditures made by the user. However, the user must navigate much data to find entries for marking as tax deductible entries. Moreover, such institutions are not required or set up to record any additional information other than the expense and the payee. With more complex payment services including dynamic smart cards to which any wallet cloud stored card may be represented it may be desired that potential tax-deductible expenditures might be marked and categorized in real time just before a card purchase is made.

One problem that arises is managing the location of receipts that back up and validate claimed expenditures used to reduce tax burden. Hard receipts are still quite common in our digital experience and are often misplaced or lost, become ink faded and illegible, and accidentally thrown away.

The inventor is aware of a system that enables a user to capture receipts form a POS terminal or from Email or messaging accounts during or just after a transaction is made by the user resulting in the receipt being captured onto the mobile phone or other mobile device hosting a transaction made from a transaction card or wireless transaction device and then uploaded to the mobile phone.

In the system known to the inventor, the user runs a wallet application or other money pay application on the mobile telephone that includes extensions connected to other useful applications available on the mobile phone such as a camera feature for taking a picture of a hard printed receipt, scanning a receipt using an optical character recognition feature, or retrieving a receipt after it is sent electronically to a user address on the network for email or from text services.

Typically, a wireless signal, push notification, or wireless command is communicated to the user mobile phone wallet application as a transaction device is read wherein the signal, notification, or command is received by the running wallet application typically connected to a cloud server where stored receipts may be kept in an organized fashion for later access by the user or an agent working on behalf of the user with authorization from the user. One feature of the system is that however the receipt is captured, it immediately displays in an application screen in the wallet or money pay application and controls may appear on screen that may allow the user to save or not save the receipt, assign a general business category to the receipt, including flagging the receipt for tax deduction purposes and filing the receipt for upload to the cloud server hosting the wallet account or money pay application.

It may be desired by a user to be able to more specifically characterize the receipt including input describing specific circumstances in the environment of the transaction, which otherwise may be forgotten if not actively recorded. Such information may help the user recall what led to the receipt more than a transaction receipt would reveal.

The inventor is aware of a method and apparatus for electronically characterizing captured receipts through a wallet or money pay application feature that may trigger just after a transaction, the characterizations attached as data to aggregated receipts before archiving the aggregated receipts for later retrieval. After a receipt is captured, a prompt may appear in a mobile application on the user's mobile phone enabling the user to characterize the receipt captured using one of an audio recording feature or a voice-to text-feature resident on the host computing device.

In many retail POS transactions, receipts are emailed to the user's email address on file or given at the time of the transaction. Such receipts may or may not be immediately sent to the user account. In most cases the user must remember the receipt and monitor email message for the arrival of the receipt before the user may retrieve (download) the receipt. Although a user might use a monitoring feature to identify receipts from a transaction amongst other email messages, the application must be monitored by the user for state (on off) and the application may not catch all receipts from transactions or my catch receipts that the user did not want to capture.

The inventor is aware of a dedicated electronic email system for capturing receipts sent to an email address and automatically forwarding to or receiving and processing those receipts at a central network location for characterization, sorting, and archiving on behalf of a subscribing user. The email system may be a part of a user's subscription to a cloud wallet account or money pay application that is adapted to at least sort and archive captured receipts for the user. In this system a POS terminal or interface may send an electronic receipt to an email address provided by the user wherein the receipt is received and processed (sorted and characterized) at the wallet account service.

In some cases, a POS system may have a data backlog and may not be able to send a receipt right after a transaction. In another case, if the POS system has more than one email on file for a user, the electronic receipt could be sent to a wrong email account. In one embodiment, the wallet account system may generate temporary emails for user transactions associated with a single account requiring the user to be dependent on a next generated email address for making another transaction with a different account. The inventor has realized that POS retail systems are equipped to generate and print quick response (QR) codes on to receipts and advertising materials whereby a user receiving the material may scan the QR code using a mobile device with a QR code scanner/reader typically available on most mobile communications devices, which may also be used as wireless transaction devices.

A QR™ code is a two-dimensional pattern of three fixed box forms off of which a matrix of spaced forms may be provided in relation to the fixed forms to code data that may include binary data, hyperlink data, links to media content, and so on. Information may be conveyed through a QR code relative to advertisements, tracking information, stage of process, supply chain data, and so on. QR codes may be printed and then scanned, displayed electronically, and scanned, or downloaded and scanned to reconstruct the data and, if equipped, execute browser function or application execution depending on available applications and QR related application extensions thereof on the scanning device. It has occurred to the inventor that a QR-based code may transfer enough data to include even multiple pages of text that could be in the form of transactional receipt data created as a result of one or more user-initiated transactions.

The inventor is aware of a method for capturing and aggregating transactional receipts conducted at a point of sale terminal connected to a network including (a) using a transaction device, submitting digital payment account data to a POS terminal, (b) reading the submitted data at the POS terminal and authorizing the payment data for the transaction, (c) upon approval notification, generating at the POS terminal a QR code that includes the itemized receipt data, (d) publishing the QR code generated in (c) to a digital screen on the POS terminal or to a printed paper medium, (e) capturing the QR code in POS display or printed in (d) with a mobile device equipped to scan QR codes, and (f) storing for transfer over the network, the QR code or a human-readable version thereof for archival and access.

While it has occurred to the inventor that a QR code may hold substantial binary data that may be translated to text including the data comprising a transactional receipt, it is also evident that QR code systems are active in a variety of consumer service arenas. QR code systems are prevalent in advertisement systems, package or product tracking systems, supply chain systems, ticket generation systems, grocery chain member systems, and other consumer service arenas.

A challenge in bar code information distribution is that many times distributed information like QR codes offering value on printed or electronic receipts maybe inadvertently ignored, lost, or otherwise not leveraged by target consumers due to consumer neglect of collected receipts or media containing the bar codes or because of consumer ignorance of or forgetful experiences relative to the actual value data content in the QR code.

Therefore, what is clearly needed is a method of aggregating and managing value data associated with electronic bar code data captured as a receipt or with a receipt or other target media and notifying consumers of opportunities embedded in the data.

### BRIEF SUMMARY OF THE INVENTION

According to an embodiment of the present invention a method is provided for acquisition, aggregation, and management by a third party of value codes available to a client comprising (a) capturing to a network-capable computing device, one or more value codes defining value earned, awarded or otherwise directed to a client through the process of transacting or other consumer activity, (b) acquiring at the third-party location on a network the value codes captured in (a) from the network-capable device, (c) isolating the one or more value codes acquired in (b) and aggregating the value codes to a value data storage archive on behalf of the client, (d) monitoring the location of, consumer activity state of, and data generated by the client over time and comparing results against client value data content matching value code content data to client activity or data content by content relevancy, (e) upon determination of content relevancy, selecting individual ones of the archived value codes and generating a notification for the client identifying the selected value codes available to the client for use in transacting or other consumer activities, and (f) sending the notification to the client over the network, the notification containing, or at least providing immediate access to the value codes selected for use consideration by the client.

In one embodiment, the network is the Internet network including any sub-networks connected thereto. In one aspect of the method in (a) the network-capable computing device is a smart phone running a client wallet application that communicates with a parent application running on a server at the third-party network location and wherein the value codes are expressed as bar codes or quick response codes. In one aspect of the method, in (a) the value codes are included in electronic receipts or on printed receipts captured using the camera function of the smart phone leveraged by the client application. In one aspect, in (a) the value code and receipt data are embedded in a quick response code captured to the smart phone.

In one aspect of the method, in (b) the value codes are sent to the third-party location from the network-capable device. In this aspect, in (b) the third-party location on the network is a cloud-based wallet service the client subscribes to. In one aspect, in (c) the value codes are isolated from receipt data. In another aspect, in (c) the value codes are isolated from quick response code receipt data. In one aspect in (c) the value codes aggregated for storage are categorized under more than one category.

In one aspect of the method, in (d) monitoring is dependent on client activity as detected from the GPS location of the client's computing device, data generated by the client's computing device and or data stored representing client activity history stored by patronized merchant or by the wallet service account use history. In one aspect, in (d) the value data content is extracted or lifted from the value code to determine content relevancy. In one aspect of the method in (e) the value codes may be one or a combination of deals available at a shopping location or third-party offers redeemable at a third-party network location. In all aspects of the method in (f) the notifications are sent to the client's computing device over the network from the third-party location.

In one aspect, in (f) the notifications are received at the smart phone wallet application with links to the actual bar codes or quick response codes wherein the wallet application enables download and display of the codes for use in transacting. In one aspect, in (f) the notifications are sent as a result of discovery of client location. In another aspect, in (f) the notifications are sent as a result of discovery of client search content. In another aspect in (f) the notifications are sent as a result of discovery of client browser activity. In another aspect in (f) the notifications are sent as a result of discovery of expiration time of the value codes arriving within a threshold window. In an alternative aspect, in (a) the value codes are included in or otherwise associated with receipts captured through a client email account.

### BRIEF DESCRIPTION OF THE SEVERAL VIEWS OF THE DRAWINGS

FIG. 1 is an architectural view of a communications network that supports real-time electronic receipt capture and aggregation according to an embodiment of the present invention.

FIG. 2 is an elevation view of the mobile telephone of FIG. 1 executing the mobile payment application of FIG. 1.

FIG. 3 is a block diagram depicting the point-of-sale architecture of FIG. 1 and a capture event of a printed receipt according to an embodiment of the present invention.

FIG. 4 is an architectural diagram of an Email loop supporting electronic receipt capture according to another embodiment.

FIG. 5 is a process flow chart depicting steps for capturing and storing a receipt electronically according to one embodiment of the invention.

FIG. 6 is a process flow chart depicting steps for capturing and storing a receipt electronically according to another embodiment of the invention.

FIG. 7 is a sequence diagram depicting a semi-automated interaction sequence supporting voice characterization tagging of a captured receipt according to an embodiment of the present invention.

FIG. 8 is a block diagram depicting an email system and network loop for capturing and forwarding captured transaction receipts resulting from transactions executed at POS terminals or at retail Web interfaces.

FIG. 9 is a process flow chart depicting steps for receipt aggregation and characterization according to one embodiment of the invention.

FIG. 10 is an architectural view of a communications network supporting receipt capture via QR code according to an embodiment of the present invention.

FIG. 11A is an elevation view of a mobile phone displaying a receipt in the form of a scanned QR code.

FIG. 11B is an elevation view of the mobile phone of 11A displaying a receipt reconstructed from the QR code of 11A.

FIG. 12 is a process flow chart depicting steps for receipt capture and aggregation according to an embodiment of the present invention.

FIG. 13 is a block diagram depicting a network architecture supporting value code management and notification according to an embodiment of the present invention.

FIG. 14A is an elevation view of an application display of a receipt captured including a value code according to an embodiment of the present invention.

FIG. 14B is an elevation view of an application display of information of the value code of FIG. 14A.

FIG. 15A is an elevation view of an application notification presenting list information of available deals and value offers.

FIG. 15B is an elevation view of an application display presenting current value portfolio data and navigable categories.

FIG. 16 is a process flow chart depicting steps for managing value data and notifying a client of available offers in an activity-relevant manner.

### DETAILED DESCRIPTION OF THE INVENTION

In various embodiments described in enabling detail herein, the inventor provides a unique method for use in capturing electronic receipts resulting from transactions at a point of sale (POS) terminal or through a network retail Web interface. The present invention is described using the following examples, which may describe more than one relevant embodiment falling within the scope of the invention.

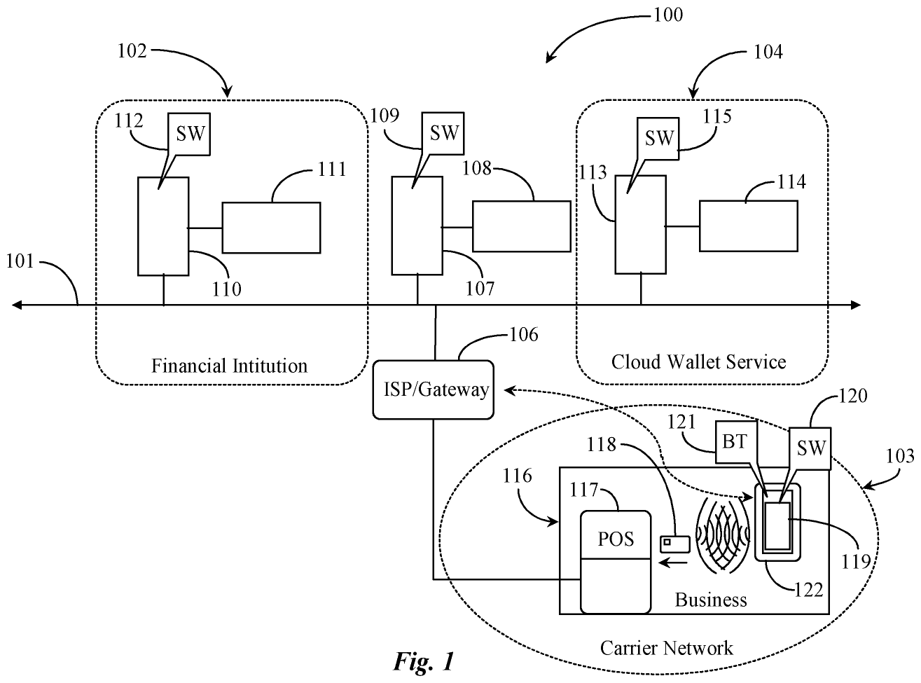

FIG. 1 is an architectural view of a communications network 100 that supports real-time electronic receipt capture and aggregation according to an embodiment of the present invention. Communications network 100 includes network backbone 101. Network backbone 101 may represent all lines, equipment, and access points, routers and gateways that make up the network as a whole including connected sub networks. Communications network 100 may be an Internet network or another wide-area-network (WAN) without departing from the spirit and scope of the present invention. There are no geographic limits to the practice of the invention.

Backbone 101 supports a network cloud labeled cloud wallet service 104. Cloud wallet service 104 may be adapted by a financial mobile cloud wallet service company to store credit card data, debit card data, and other electronic card or account data, for a mobile user, represented herein as user phone 122 having a dynamic transaction card 118 that may be programed with a selected set of card transaction data, for example, to make a specific transaction. Cloud wallet service 104 includes a server 113 supported by back bone 101 running a software (SW) application 115 and coupled to a data repository 114. SW 115 may be a cloud wallet application for a dynamic transaction device like card 118 or another device used to interact with a sales or banking terminal (electronic machine/network node). Data repository 114 may include user identification and profile data, user accounts data, financial history data including transaction history, cloud wallet account data and the like.

Communications network 100 may include one or more financial institution domains 102 interfacing with a bank, credit union, or other financial account service site that may provide banking services to user 122 as a client. Domain 102 is a financial institution that may issue a financial transaction device to user 122 based on client status and account information. Financial institution 102 broadly represents entities that may be considered financial institutions with services used by user 122 like banks, credit unions, investment houses, etc. Financial institution 102 includes a server 110 supported by back bone 101. Server 110 hosts a software (SW) application 112 adapted to provide an electronic interface as a tool to user 122 for account use and management. SW 112 may include at least one component adapted to cooperate over a network with SW 115 running on server 113 in cloud wallet service domain 104.

Communications network 100 may include at least one network-based retailer selling products or services referenced herein by a server 107 supported by backbone 101, a software (SW) application 109 executing on server 107, and a data repository 108 coupled to server 107. Server 107 may represent any entity (network node) accessible to the user where a transaction may be performed. Data repository 108 may hold service and product related data, and user interaction and any transaction history user 122 has at the site.

Access to communications network backbone 101, which may represent the Internet in one embodiment, may be through an Internet service provider (ISP)/access Gateway 106 supported by backbone 101. A carrier network 103 is depicted that enables communications including wireless communications to be bridged onto communications network 100 through ISP Gateway 106. Carrier network may be a wireless 5G network or similar mobile network that user-operated mobile phone 122 may use to access the network and practice local and long-distance communications using the representative mobile telephone. Mobile telephone 122 may be Bluetooth™ enabled by hardware and software (SW) 121 labeled BT. Mobile phone 122 may host a software (SW) application 120 adapted as a thin mobile SW application including a network connection and browsing ability that may locally display information screens like screen 119 in display on mobile phone 122.

The user operating mobile phone 122 is at a business domain 116 that may be a service site, restaurant, retail establishment, parks service, or any venue that user 122 may enter to buy a product or service. In this embodiment, business 116 includes a point of sale (POS) machine or terminal 117 that takes, at least, credit and debit cards for satisfying financial transactions made by user 122. In this embodiment, user 122 has a dynamic universal transaction card 118 that may be electronically associated to a funding source account and may be accepted by terminal 117 to pay for goods or services. In a preferred embodiment, user 122 may transmit account data to card 118 from the mobile telephone while running SW 120 and SW 121 wherein the card 118 is Bluetooth™ enabled to at least receive the account data (card number) wherein the account data represents an account that user 122 has represented in cloud wallet service 104.

User 122 may have several different accounts represented in cloud network 104 and dynamic transaction card 118 may be loaded with any of the user's account data to use that account to pay for goods or services during a transaction. SW 120 on mobile phone 122 enables the user to interact with cloud network 104 just before using card 118 at POS terminal 117 so that the user may determine which of several accounts might be imprinted or sent to card 118 for use as a device representing that account.

Cloud wallet application screen 119 on mobile phone 122 may be part of the interactive interface available to the user operating mobile phone 122 to load card 118 with a card number, security code, and other pertinent data so the card may be used as a card of the selected account. Any new account data that the user loads onto card 118 may overwrite any previous account data on the card memory.

In a preferred embodiment, SW 115 executing on server 113 in cloud wallet service 104 is adapted to at least receive and file electronic receipts on behalf of the active user operating mobile phone 122 in near real time. Card 118 may be used as the transaction device to pay for one or more transactions at POS terminal 117, the card written to by mobile phone 122 executing application 119 in broad respect while card 118 represents a particular account listed in cloud wallet service 104.

In one embodiment, the user may capture a hard receipt (not illustrated) associated with any transaction initiated and completed with card 118 that is printed out in form by POS terminal 117 immediately after a transaction is performed. In one embodiment, the hard receipt associated with a transaction performed with card 118 may be captured by a camera/scan application (not illustrated) resident on mobile phone 122. SW 120 may include an extension of SW 120 to an application on mobile phone 122 like a camera application. A receipt capture may be a semi-automated sequence of events that are triggered by a transaction event having occurred.

In this embodiment, dynamic card 118 may be used to conduct a transaction that will produce a receipt and may be enabled for wireless communication. In one embodiment, dynamic card 118 may send at least a data notification, a push notification command, or signal over the wireless link to mobile phone 122, for example, by Bluetooth™ wireless network (bi-directional line patterns). For example, dynamic card 118 may communicate via Bluetooth™ or other wireless protocol to mobile phone 122, the data notification, command, or signal, verifying that a transaction has been completed at POS terminal 117 and a receipt is forthcoming.

The communication may, in one embodiment, function as a direct command to execute a camera application resident on mobile phone 122 using SW 120 and interface 119. In another embodiment, the communication may be a simple notification with sound, flash or other haptic feedback that may prompt the user operating mobile phone 122 via a pop-up or other visual notification appearing in screen 119 that a transaction has occurred, and a receipt is forthcoming and may be electronically captured.

In one embodiment, paper receipts are printed at the POS terminal 117 after a transaction is conducted and wherein the dynamic card 118 communicates a signal triggered by the read operation at the POS terminal, the signal processed by the cloud wallet application causing a camera application, via application extension, to execute automatically on mobile phone 122 to ready the camera or scanning device to capture/scan the printed receipt including the last four digits of the account number, the date, time, name of business, and items, service descriptions, and any other important information printed on the receipt paper.

In one embodiment, POS terminal 117 does not print a hard receipt but displays an electronic receipt on a display screen after the transaction that the user operating mobile phone 122 may see and use the phone to capture the display by image capture or scanner before the electronic receipt is requested by the user to be delivered to mobile phone 122 by email.

Optical character recognition (OCR) may also be employed, for example, during scan to render the electronic receipt editable if desired as an option to allow another application to manipulate data on the receipt, for example, enabling copy of some receipt data but not the whole image, or redacting or otherwise hiding or obscuring some of the receipt data, such as the merchant name, for example.

In another embodiment, the user operating mobile phone 122, wherein the mobile phone and the POS terminal are enabled for near field communication (NFC), may be using the mobile phone without an intermediate transaction device to transfer the correct wallet account information at the POS NFC interface to conduct a transaction. In both of these embodiments, the mobile phone 122 may capture a hard receipt or an electronic receipt displayed on a POS screen.

In still another embodiment wherein the POS terminal is not connected to a printer and has no display capability, a receipt may be captured electronically from the user's email account or messaging account if the merchant electronically mails or otherwise propagates the receipt to an end device controlled by the user. SW 120 may in addition to having a SW extension or application programing interface (API) to the user's camera application and permission granted by the user to grant the applications use the camera application or scanning application on the user's mobile phone 122, have extensions and or APIs to the user's email and text messaging applications where a receipt from a transaction conducted at a merchant POS terminal.

In the above scenario, the cloud wallet application may monitor the user's email or messaging account and may grab or capture the receipt from a merchant as an attachment to the email or text message. In a variation of this embodiment, the wallet application may be further enhanced with a SW extension that allows the application to use a screen scraping utility or snap-shot utility to capture a receipt in display (but not attached) in an open email window on the user's mobile phone where the wallet application may be further enhanced with a capability to open email messages.

A stated goal of the invention mentioned above and in addition to capturing receipts is to also aggregate receipts from transactions conducted by the user wherein the receipt aggregation is performed by cloud wallet account SW 120 executing on the user's mobile phone 122. The application may redirect those receipts (upload) to the cloud storage repository 114 at the wallet account domain 104 for later retrieval by the user or by an agent working on behalf of the user in tax planning, accounting, credit counseling, or other like services where user receipts must be accounted for.

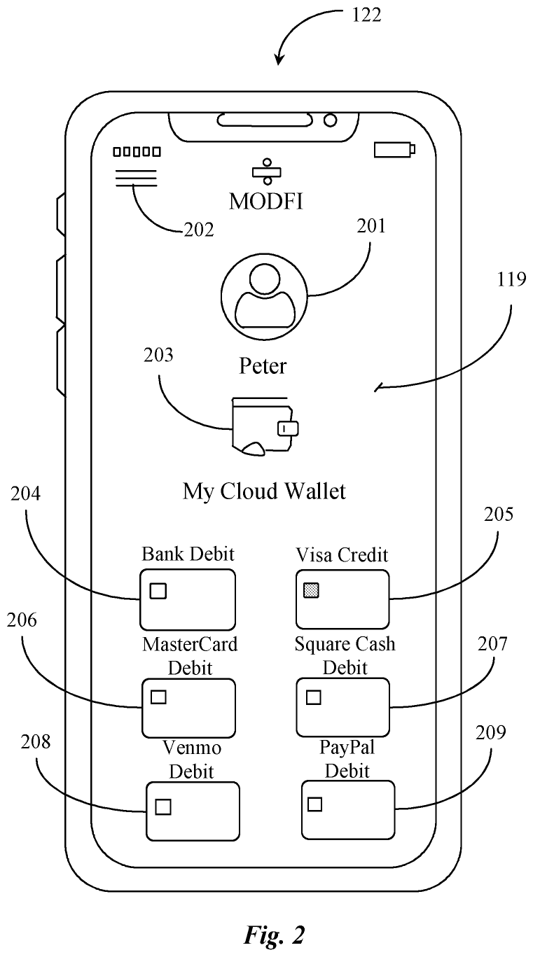

FIG. 2 is an elevation view of the mobile telephone of FIG. 1 executing the mobile payment application of FIG. 1. Mobile phone 122 has in display screen shot 119 depicting a cloud wallet account held by the user. In this embodiment, the account is a MODFI cloud wallet account known to the inventor and subscribed to by the user. However, any cloud wallet account or money payment application may be easily modified to practice transaction receipt capture and aggregation without departing from the spirit and scope of the invention.

Interface screen 119 includes a menu 202 of a variety of options that a user may invoke while using the application. The application is personalized to the user 201 and provides access to account data for all of the accounts that user 201 (Peter) has uploaded the information for in order to include the accounts as possible payment accounts that may be selected to fund initiated transactions. An icon 203 represents a folder or “wallet” listing all of the user accounts added to the service. Expanding wallet 203 may display several accounts separately for browsing, updating, or selection for a transaction. In this embodiment, accounts 204 through 209 are listed where 204 is a bank issued debit card account, 205 is a Visa issued credit card account, 206 is a MasterCard debit card account, 207 is a Square Cash debit card account, 208 is a Venmo debit card account, and 209 is a PayPal debit account.

User 201 may have in possession a dynamic transaction device like transaction card 118 of FIG. 1 and may using interface 119, select any one of accounts 204 through 209 to be assigned to the transaction device to use that account to fund any transaction as well as other tasks like using the dynamic card 118 loaded with any of the account data sets to access the account through an ATM terminal for example. In this embodiment, a user may select any one of accounts 204 through 209 and load that account data set onto the transaction device, for example, card 118 of FIG. 1, to perform a transaction with the card having the funds for the transaction deducted from the selected account.

The function of loading a dynamic card like card 118 of FIG. 1 with selected account data overwrites the existing account data on the card. A user may make more than one transaction with the transaction device loaded with a selected account and may overwrite the transaction device with any new account data (swapping accounts) making the next transaction associated with the next payment account data downloaded to the card. Using a transaction card with a writable memory is not required in order to practice the invention. A dedicated transaction device may be used provided the account on the card is represented in the client application and the electronic transaction record the card will be used to satisfy is accessible to the client application.

In one embodiment, receipt capture is a dynamic process occurring once at the relative moment in time of each transaction made. In one embodiment, the user may select the account desired for funding a next transaction and may capture a receipt upon evidence thereof at the POS terminal or interface.

In one embodiment, the user may click on any one of the listed accounts and mobile phone 122 may transmit an account data set from the selected account to the dynamic card (118), and may the receive a signal, command, or notification from the wireless card just after transacting with the POS terminal. The signal, command, or notification results in automatic execution through the cloud wallet client application of the camera application or feature thereof such as the imaging and/or scanning feature. The signal, command, or notification may include an audio beep or other sound or vibration to gain the attention of the user operating phone 122 if the user is not already focused on receipt capture.

The user operating phone 122 may typically have a copy of a bill digitally available to mobile phone 122 either by transmission thereto or by optically scanning the bill that documents the transaction details before the card is inserted or otherwise used and before a receipt is issued by the merchant after the card data is either approved by checking the source account identified on the card. This information may be propagated from the user's mobile phone or device 122 over the communications network to the cloud network to be associated with the actual transaction event (card insert/swipe).

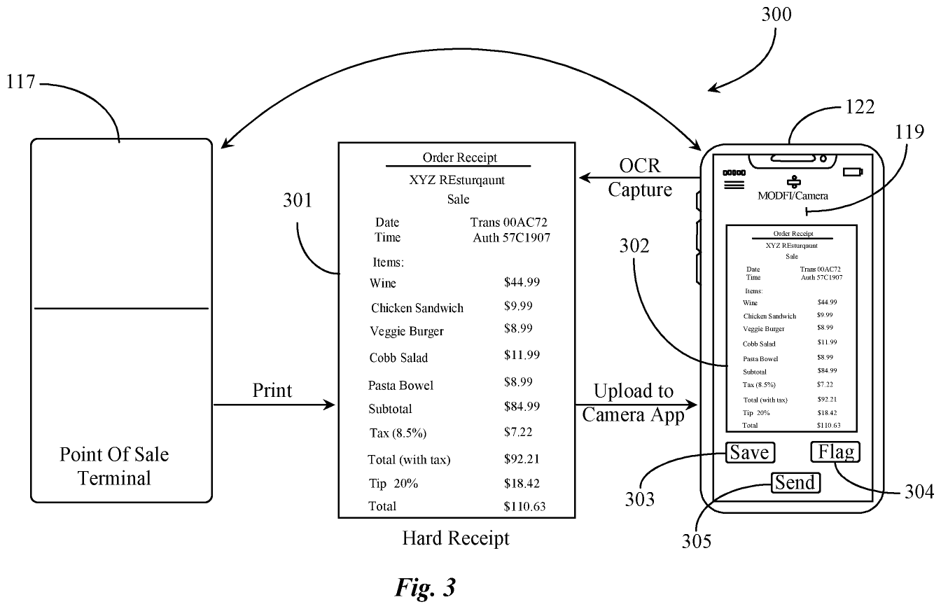

FIG. 3 is a block diagram depicting a receipt capture event of a receipt printed out by POS terminal 117 according to an embodiment of the present invention. POS terminal 117 is, in this embodiment, a POS terminal connected to a printing function and prints out a hard paper receipt referred to herein as receipt 301 after each transaction. Most In-person check-out counters offer this service. In this example, hard receipt 301 is a restaurant receipt including a date and time of the transaction, a transaction number, and an authorization number. The hard receipt lists the items purchased and the broken-down costs of each item, the percentage of sales tax, the tip amount, and the totals with tax and before tip and the grand total of the bill paid.

Receipt 301 may result from a dynamic card transaction like with dynamic card 118 or a mobile phone NFC transaction by mobile phone 122. In a case of transacting with a dynamic card like card 118 described above or perhaps another Bluetooth™ enabled transaction device that may be adapted to work with the cloud wallet application on phone 122, a signal, command, or notification may be communicated from the transaction device to the mobile phone as the card is being read. The signal, command, or notification may be received at phone 122 by application screen 119. Upon receipt of the communication, the application may execute the camera and scanning application feature used to capture hard receipt 301. In this way the user does not have to remember to capture the receipt once it is printed. The signal may be a text of the receipt at phone 122.

The automated execution of the capture features of the user's camera application may include a vibration or notification sound so the user will feel or hear it and take the task of positioning the capture hardware to capture or scan the receipt. Once the hard receipt 301 is captured and is on mobile phone 122, the image of the receipt may be displayed as receipt image 302 on application screen 119. In this embodiment, the user may select to save the receipt by selecting a save function 303. This function may save the receipt to a specific folder on mobile phone 122. In one embodiment, the user may also categorize captured receipt 302 as a wholly or partly tax-deductible receipt by selecting a flagging option 304. The user may also select a send option 305 that, if selected communicates the electronic receipt copy 302 to the cloud wallet service for processing and storage.

It is noted herein the image capture feature used in the camera application captures the receipt and uploads it to the cloud wallet screen 119 on mobile phone 122 as electronic image or OCR'd document 302. In one embodiment, receipt 302 is a static image and cannot be manipulated by software and is stored as an image file at the cloud wallet service. In another embodiment, captured and displayed receipt 302 is an electronic document manipulate-able by SW 120 on mobile phone 122. A user may be enabled to redact a portion of the receipt or even recalculate what the user has actually paid considering the possibility of a receipt that might be the result of a shared transaction where the user was reimbursed for another user or user's shares of the bill.

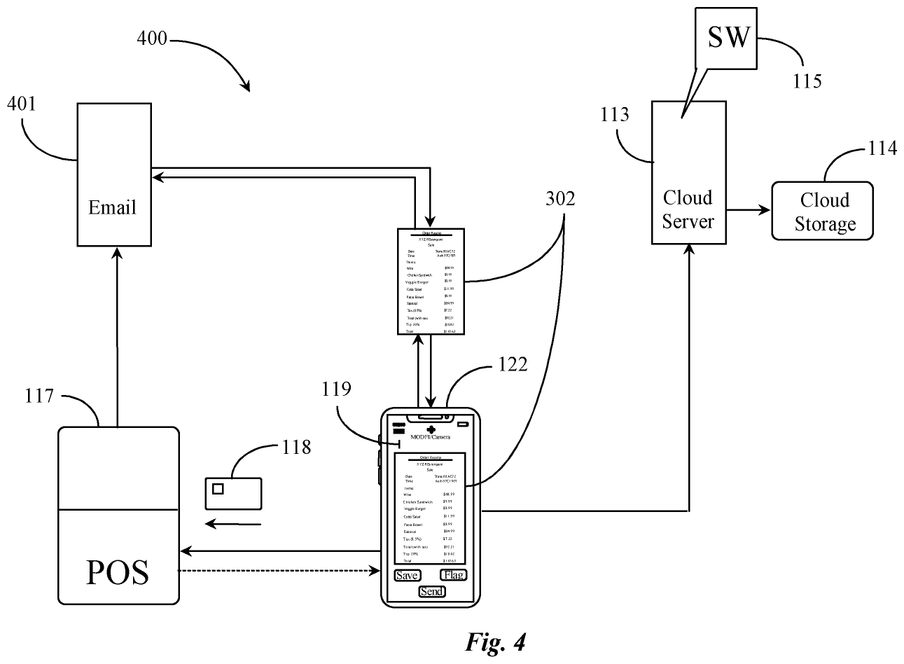

FIG. 4 is an architectural diagram of an Email loop 400 supporting electronic receipt capture according to another embodiment. In this example, POS terminal 117 does not print out hard receipts that the user might capture using mobile phone 122. Therefore, it is assumed in this embodiment that the merchant has the email address or phone number of the user. In one embodiment, the user may give the person the correct email address at the time of the transaction if the merchant does not already have the address in the system.

In this embodiment, the user operating mobile phone 122 has application screen 119 running when he or she initiates a transaction at POS terminal 117 using dynamic card 118. At the time of transaction when the card is read and approved for the transaction amount, POS terminal sends an electronic receipt to the user's email or text account referenced herein as email server 401. Card 118 may include Bluetooth™ enablement and a micro controller unit (MCU) on board and sends a signal, command, or notification via Bluetooth™ to mobile phone 122 that is received by application screen 119.

Application 120 may include an extension to automatically open the user's email or text account to retrieve email. The email feature of the user's email account may log into email server 401 and retrieve the email from the merchant that includes the attached or embedded email receipt 302. In this embodiment, the email attachment or embedded receipt 302 displays in application screen 119. The application may upload receipt 302 to cloud server 113 aided by SW 115 and the cloud wallet service may archive the receipt for the user in cloud data storage 114.

It may be noted that a number of tasks may be performed relative to receipt 302 by the user operating SW 120 on mobile phone 122. The receipt might be flagged as a tax deduction, flagged for reimbursement, checked for correct math, and corrected as for total amount (if incorrect), marked as a shared transaction where the user may append the receipt to include the user's actual amount paid.(shared transaction), or redacted in portion by the user. In a preferred embodiment, receipt 302 is processed in a semi-automated manner so that the user may not forget about the receipt and have to find it again at tax time.

The semi-automation during transaction and upload to the cloud wallet service ensures that the receipt is aggregated and not left out or forgotten by the user. The signal command or notification made from card 118 ensures the user will at least be aware that the receipt is available and may be immediately aggregated and stored. The cloud wallet service (104, FIG. 1) may archive receipts like receipt 302 according to the accounts sourced to pay for the transactions.

In one embodiment, receipts that are archived in separate account activity histories may be retrieved according to receipt category. For example, a user operating a mobile phone through application screen 119 might retrieve all receipts that were fuel and toll receipts that may be travel expenses though the receipts are archived by the cloud wallet accounts that funded the transactions producing those receipts. Receipts that are printed and captured or captured electronically are aggregated and are retrievable by the user or agent working on behalf of the user like a tax preparer or a certified public accountant (CPA). In one embodiment, a user may simply capture a receipt that is handwritten, or one that resulted from a transaction where cash was used to pay a bill and may upload that receipt to the cloud wallet service if the user has reason to like the transaction being tax deductible.

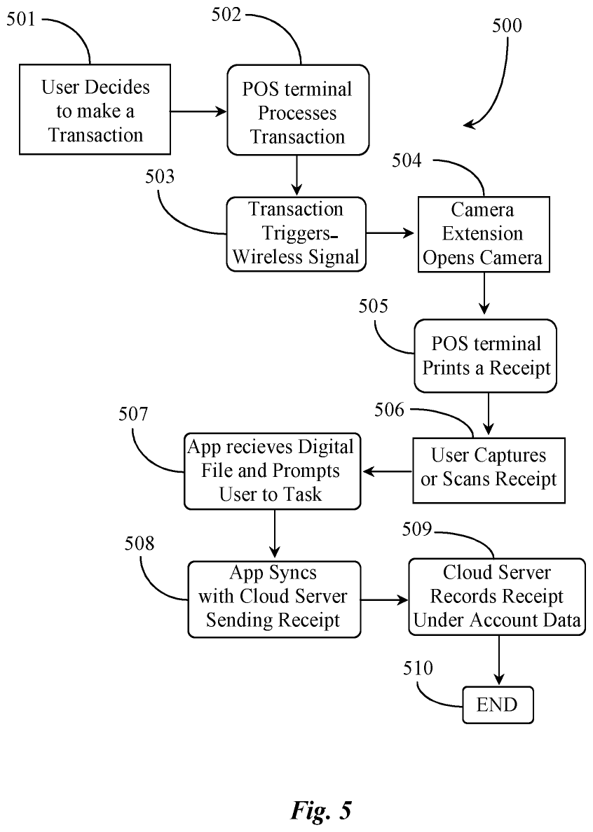

FIG. 5 is a process flow chart 500 depicting steps for capturing and storing a receipt electronically according to one embodiment of the invention. At step 501, a user operating mobile phone 122 as a transaction device or as a parent to a transaction device like dynamic card 118 of FIG. 1 initiates a transaction at a POS terminal. At step 502, the POS terminal processes the transaction. At step 503, the transaction event (card read/approval) is detected by the transaction device, in this case, a dynamic card analogous to card 118 of FIG. 1. Card 118 sends a wireless signal, command, or notification in step 503 that may cause the user's camera or scanning application features to open in step 504 in association to SW 120 and screen 119.

At step 505, the POS terminal 117 may print a hard paper receipt. The user, having received signal notification or direct command, captures, or scans the receipt at step 506. In this step the signal, notification or command executes the camera or scan feature through the screen. The signal, notification, or command may include audio alert or vibration sequence, so the user does not miss the opportunity to use the executed feature to capture the receipt by imaging or scanning, the receipt uploaded to the user's mobile device.

At step 507, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 508, the application may synchronize with a cloud wallet server analogous to server 113 of FIG. 1 aided by SW 115 and may send the now electronic receipt to the cloud wallet service for archiving on behalf of the user. At step 509, the wallet service may record the receipt under the account data for that receipt or in the activity log for the wallet account that funded the transaction. The process may end at step 510. It is noted herein that the user may through the client application, connect to the wallet service and review receipts, retrieve receipts, search for specific receipts by category, or by date, and so on.

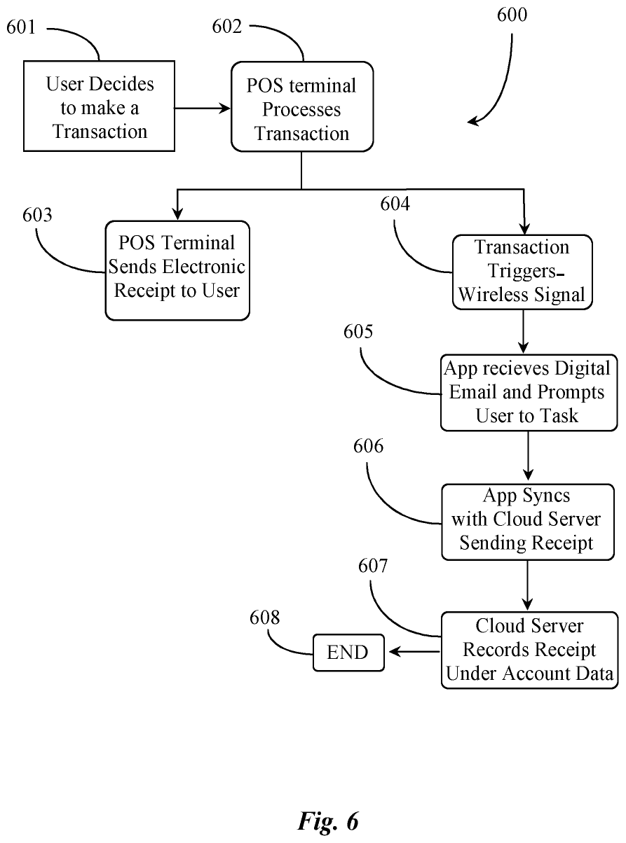

FIG. 6 is a process flow chart 600 depicting steps for capturing and storing a receipt electronically according to another embodiment of the invention. At step 601, a user operating mobile phone 122 as a transaction device or as a parent to a transaction device like dynamic card 118 of FIG. 1 initiates a transaction at a POS terminal. At step 602, the POS terminal processes the transaction. The transaction event (card read/approval) is detected by the transaction device, in this case, a dynamic card analogous to card 118 of FIG. 1. At step 603, the POS terminal analogous to terminal 117 of FIG. 1 sends an electronic receipt to the user, typically via text or email account known to the merchant and wherein the email was provided by the user at some point in the past or is provided during the transaction.

At step 604, card 118 sends a wireless signal, command, or notification that may cause the user's email request feature to execute and open in association to SW 120 and screen 119. In this step the signal, notification or command executes the email request feature through the screen. The signal, notification, or command may include a text, audio alert or vibration sequence, so the user does not miss the opportunity to use the executed feature to capture the receipt by downloading the receipt to the user's mobile device.

At step 605, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 606, the application may synchronize with a cloud wallet server analogous to server 113 of FIG. 1 aided by SW 115 and may send the now electronic receipt to the cloud wallet service for archiving on behalf of the user. At step 607, the wallet service may record the receipt under the account data for that receipt or in the activity log for the wallet account that funded the transaction. The process may end at step 607. It is noted herein that a user may skip, or override receipt capture as detailed in processes of FIG. 5 and of FIG. 6 if that user does not wish to save a receipt for a transaction. In one aspect of both processes, a user may configure transaction accounts in the cloud wallet service to require receipt capture whenever that particular account or accounts are used.

In one possible embodiment, a dynamic card enabled for Bluetooth™ and having a writable memory may receive an electronic image from the POS if the POS is enabled to write such as image to the card. The dynamic card may, in that case send the electronic receipt back to the mobile phone over the wireless connection. In still a further embodiment, the dynamic card may have a screen scrape application provided in available memory allocated for the purpose and may copy an image of the receipt displayed in a display screen on the POS terminal, however, a POS terminal would have to be modified with an electronic access or read path from the card slot interface directly to the display screen.

The just described embodiment may not be preferred for security reasons that the card may capture a different receipt image but electronically it is possible for a device having an MCU and a thin firmware executable on the card to capture the contents of the POS screen. In that case, the card may immediately communicate the captured image to the mobile phone or may transfer the image, for example, when docked with the phone as is known to the inventor for one type of dynamic transaction card.

### Voice Enabled Tagging and Receipt Characterization

In one embodiment of the invention, a user may voice-tag a captured receipt using voice to text capability on the user's mobile telephone analogous to phone 122 of FIG. 1 aided by SW 120.

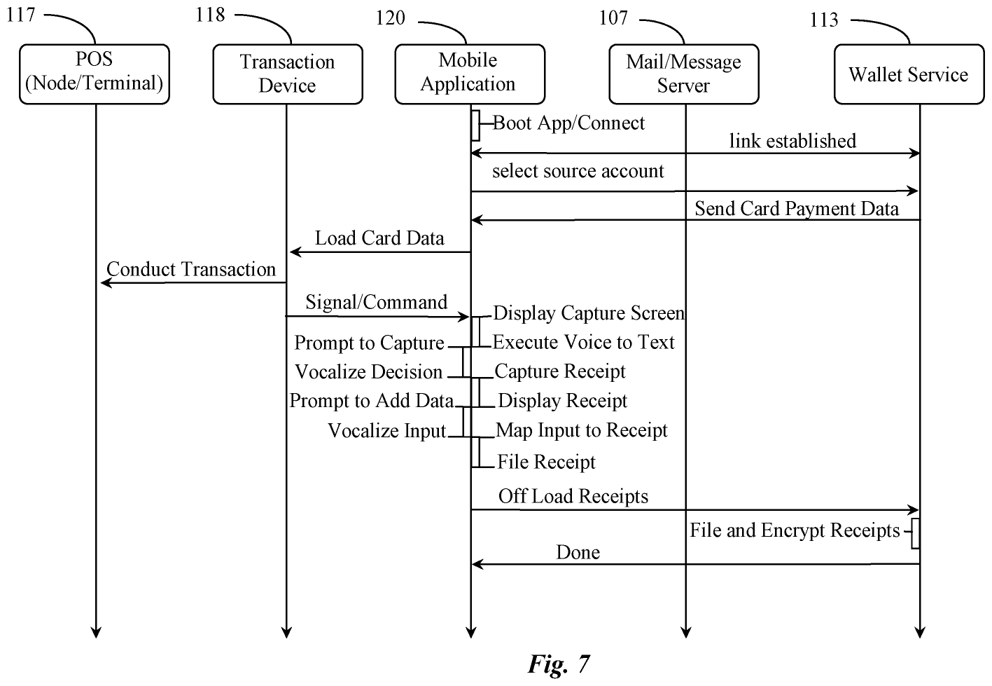

FIG. 7 is a sequence diagram depicting a semi-automated interaction sequence supporting voice characterization tagging of a captured receipt according to an embodiment of the present invention. A user operating a mobile telephone and using a transaction device or the phone itself as a transaction device can interact with any point of sale (POS) terminal or node to affect receipt capture as described further above. Before engaging with a POS terminal to transact through the terminal, the user executes or boots a wallet application 120 resident on the mobile telephone or other mobile device having connection to a cloud wallet service or other network-based money payment SW service.

A working network connection is then established over the network with a network server 113, referred to herein as wallet server 113. As described further above, this enables the user to select a source account to cover for a transaction, for example, when using a dynamic writable transaction card or other writable transaction device.

Wallet server 113 sends the requested card data in encrypted format to the user, typically to the user's mobile device running the wallet application 120. The user may receive the card data in the wallet application and may send that card data to a transaction device like device 118 (dynamic card) via a wireless communications protocol like Bluetooth™. The card data communicated to the card overwrites and other card data that was on the card. Thus, the user loads the card data received from server 113 onto dynamic smart card 118 prior to initiating a transaction at terminal 117.

The user may then use card 118 to conduct the transaction wherein POS terminal 117 reads the loaded card data from a magnetic stripe or reader interface when the card is inserted. At the time reading occurs, a signal push notification or command is sent back to the user's mobile phone to cause the wallet application to execute one or more features in other resident applications that may be useful in receipt capture. In one embodiment, the wallet executes a voice input feature like a microphone application feature which enables the user to speak into a microphone on the mobile telephone. The mic feature enabling voice to text (VTT) may be executed automatically via a SW extension provided in SW 120 from inside the application on user's microphone.

If wallet application 120 is not running on the phone then the signal, command, or push notification may be received by a watch extension and used to open SW 120, which in turn may immediately execute other appropriate features resident in other applications on the phone. More particularly, the signal command or notification may result in a display of a receipt capture screen analogous to screen 119 of FIG. 1, while executing a voice to text feature or an audio recording resident on the mobile phone.

A first prompt to the user may appear on screen asking if the user wishes to capture the forthcoming receipt for the instant transaction. The prompt may be a simple phrase Capture Receipt, Followed by a yes and a no touch screen option. If the user wishes, the user may say yes or no into the microphone to continue with the process. If the user declines, the sequence ends because the user is not interested in that particular receipt. In the event the user wishes to capture the receipt, the user may vocalize that decision by saying yes or touching the yes option on screen.

The application 120 may, as a result of a yes answer, execute the receipt capture feature via SW extension and user permission. The user may then capture the receipt using on or another executed feature. In one aspect of this sequence more than one capture feature might be offered like a camera imaging feature, a message retrieval feature, or a scan feature using optical character recognition (OCR). Once the receipt has been captured, it is immediately displayed on the application screen 119 so the user may visualize the receipt and, in some cases, manipulate the receipt according to options provided like redaction, enlarge, crop, etc. that may be provided in a pane on the capture screen showing the receipt.

Once a user is satisfied with the receipt in display, the user may save the receipt in its current form and a prompt may appear asking the user if the user wants to add any characterization data to the receipt. The receipt has information that helps categorize it and that information may be used in archiving etc. However, the user may want to describe a business situation including names of parties to a transaction etc. depending upon the type of transaction.

Rather than manually typing data into a screen dialog box from a small keypad typical of a mobile phone, the user may use the voice to text feature or make a voice recording to input characterizations about the receipt including any details the user cares to vocalize. In one embodiment, the user makes a recording, and that recording is saved as an audio recording and transcribed later and associated with the receipt. In another embodiment, the user vocalizes characterizations that appear as typed text in a voice to text scenario wherein the text is associated or tagged to the receipt.

Either input type, audio recording, or voice to text input is mapped or linked to the receipt on the user's mobile device. After the user has finished characterizing the receipt, the user may hit save or done in the screen and the application may file the receipt for later upload or offload onto another device or to the cloud wallet service 104 introduced in FIG. 1 above. Any time after the transaction, the user may upload the receipt and the associated data and or media to server 113 at the cloud wallet service 104. Once in house, the SW 115 running on the server may transcribe audio attached to the receipt and create a text record as well as save the audio if the user prefers. The receipt and audio, text characterization files may be stored together according to user metrics or a user-created file system.

In one embodiment, the wallet service files the receipts and associated data or media under the activity histories of the accounts that were used to cover the transactions. In some embodiments, a user may create a single archive containing all of the receipts, data and media associated therewith. In this embodiment, the receipts may be searched according to any of the metrics on the receipts including account source and any data metrics provided by the user in receipt categorization. The features residing on the user's mobile phone may be resident features of other applications that are tied to application 120 through extensions such that they may be borrowed as application features of application 120.

The exact method used to capture the receipt initially may be any of the features previously described above. A user may also say no to receipt characterization using voice and instead operate with standard receipt categorizations offered as interactive options in the application screen 119 such as gas receipt, business trip hotel receipt, car rental receipt business trip, etc. Once the user has the electronic version of a receipt captured, the user may practice the categorization and characterization methods while connected to server 113 or while offline.

### Automated Aggregation of Electronic Receipts

In one embodiment of the invention, a user may provide a dedicated email address to aggregate receipts for forwarding to a central location in a cloud service where they may be sorted and made available to users operating a network device with an application to access those receipts and tools to characterize, flag, and manipulate certain receipt data and provide meta data about those receipts.

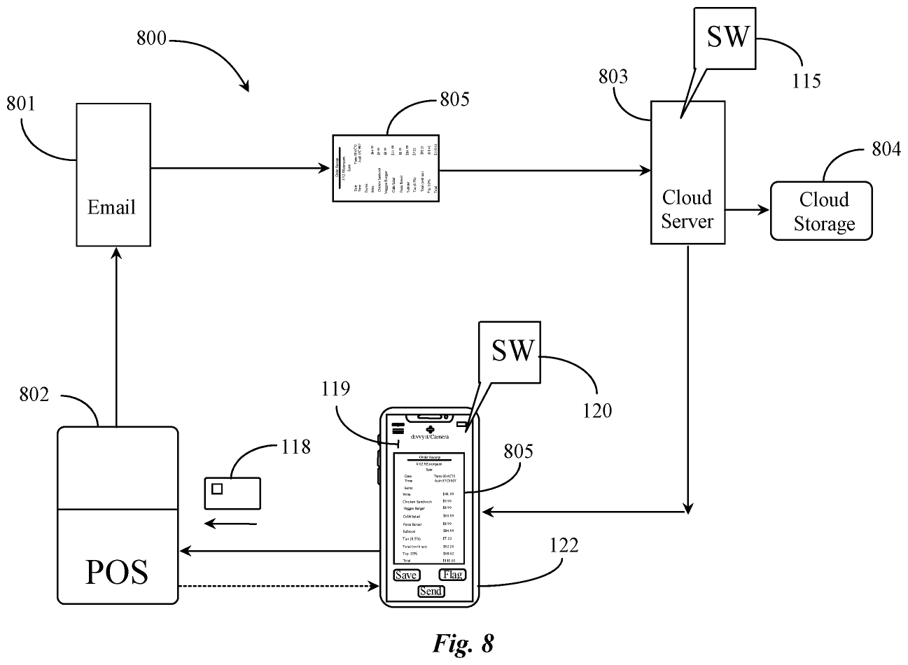

FIG. 8 is a block diagram depicting an email system and network loop 800 for capturing and forwarding captured transaction receipts resulting from transactions executed at POS terminals or at retail Web interfaces. Network loop 800 refers to a data network loop or path involving a point of sale (POS) terminal or network node 802 having at least a network connection to an email server 801, which has direct network path access to a cloud server 803 with access to cloud storage 804, the server aided by SW application 115 whereby the cloud server/SW and email domain are part of a cloud wallet service subscribed to by the user.

A user operating mobile phone 122 aided by SW 120 (thin download-able client app. of SW 115) depicting application screen 119 may execute a transaction for goods or services at POS terminal 802 using a, for example, universal smart card 118 with writable memory for excepting card data from the user's cloud wallet service via a wireless transmission from the mobile device 122 to the card 118.

In many cases of retail, the user may shop regularly and may already have an email address on record with the merchant operating the POS terminal. In a preferred embodiment, the user's cloud service provides an email aggregation service and may issue a special unique email address to the user. The email address is a dedicated email address for receiving and forwarding at least the electronic receipts resulting from transaction approvals obtained by the POS terminal or transaction debit acceptance events at the POS terminal for a credit card.

A user may provide the receipt aggregation (RA) email address to any merchant as part of a membership to the merchant site or simply as a contact email address the merchant will keep on file for future interaction. POS terminal 802 may generate a receipt 805 for a transaction handled with card 118 and may send a copy of the receipt to the user's provided email address. Email server 801 may be a dedicated and controlled server operated by the cloud wallet service as architectural feature support for the service. Email server 801 may be programmed as a mail stop for user receipts that are, as soon as received, forwarded to cloud server 803 aided by SW 115.

In this way, the user operating mobile phone 122 does not have to pay attention to the receipt 805 or remember to access the receipt. Once the receipt 805 is at cloud server 803, email source identifies the user and security may be maintained within a single domain. Cloud server 803 running SW 115 may use available knowledge about the user and recent user activity to sort the receipts or map the receipts to a credit or debit account maintained at the cloud service hosting server 803.

When receipt 805 is archived in repository 804 (cloud storage), server 803 may push a notification to mobile phone 122 informing the user the receipt 805 is accessible to the user for review, tax flagging, or other possible tasks that the user may perform to the electronic receipt file through application screen 119 of SW 120 (receipt 805 depicted on screen 119).

In one embodiment, aggregated receipts may be sorted, categorized, and filed on behalf of users at cloud server 803 connected to repository 804 before the service sends a push notification to application 120 running on mobile phone 122 that a receipt (805) is processed and available for user access through application 120 for display in screen 119. In this embodiment, the user may follow a link in the notification or click on the notification to view the receipt through application 120 and have access to tools for performing tasks relative to the receipt.

In one embodiment, a user operating mobile phone 122 may access email server 801 as an Internet Email Access Protocol (IMAP) client to view captured receipts as aggregated on server 801. In one embodiment, a user may subscribe to the dedicated email service and use the email service for correspondence (sending and receiving email) like any other email account. In this case receipts may be isolated to one sub-folder of a general in-box where the receipts may be found.

One useful aspect of keeping receipts in an isolated email folder is convenience to the user in accessing the folder for view and refresh. The timestamps on the emails in the receipt in box closely correlate with the date and time of transaction at the merchant POS terminal 802. In an alternate embodiment, the email system is dedicated to receiving receipts from any transaction the user makes where the POS terminal or network node that generates the receipt on behalf of the merchant emails the receipt to the email address of the user. In this embodiment, the receipts are aggregated and forwarded to the cloud service where there may be no direct records left of the receipts on the server rather just the email bodies that delivered them. In a typical use embodiment, the cloud service may notify a user of receipt accessibility through the mobile application running on mobile phone 122. In one embodiment the service issues temporary emails to users who have selected cloud wallet accounts to transact using a dynamic card. In this case, the email is temporary and is only provided to aggregate the receipts from transactions made using one account. After the user selects another account a new email is generated and sent to the user along with the card account data. The user may submit the temporary email address to the merchant through the POS interface or terminal using a wireless card or by typing the information into a web interface.

In one embodiment, the cloud wallet service generates a new and unique email address for a subscriber for the purpose of capturing receipts and associates that email address, which is a temporary address to the account that the subscriber is using to conduct the transaction(s). In this embodiment, the POS may receive the temporary email address during the transaction and may automatically send the electronic receipt to that email address. In this way, no data is saved after aggregation of the receipts and when the subscriber selects a new account to use for new transaction(s) a new email address is generated for the purpose.

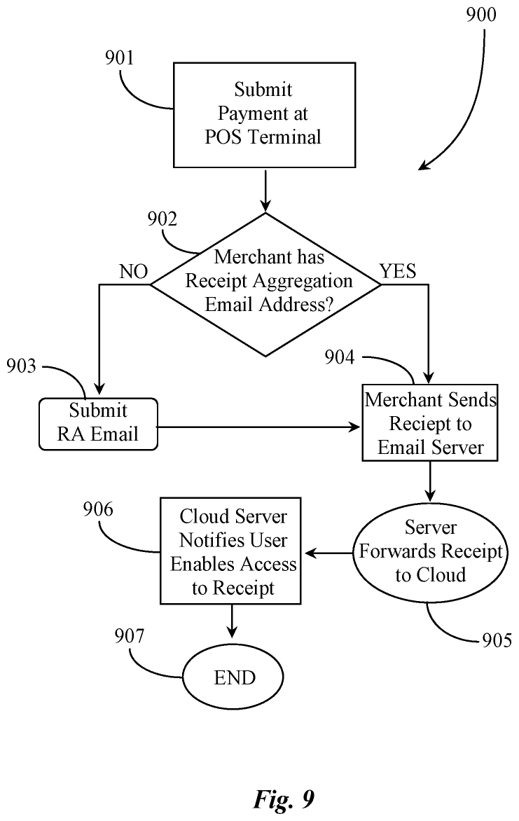

FIG. 9 is a process flow chart depicting steps 900 for receipt aggregation and characterization according to one embodiment of the invention. At step 901, a user may submit payment using a payment card or transaction device at a POS terminal hosting a transaction. In one embodiment, the POS terminal is a Web interface and the transaction falls into a category of an online or network transaction. At step 902 a determination is made whether the merchant has the user's RA email address. The RA email address may be known to the merchant already. In another aspect the user must give the merchant the email address during the transaction.

If at step 902, the merchant does not have the email address, the user may update the merchant files with the RA email address at step 903. As with all email addresses, the user's name or handle may be part of the address and the domain may be the second part or last part of the address, for example, peter22@cloudwallet.com, for example. The address is special because it is dedicated at least in part to aggregate all of the user's electronic receipts that are sent to the email address. If at step 902 the merchant has the address or after the user has submitted it to the merchant at step 903, the process moves to step 904 where the merchant sends the receipt for the transaction directly to the RA email address.

At step 905, the email server may immediately forward the transaction receipts on to the cloud wallet service for processing. In one embodiment, an RA email address may be substituted for the user's normal correspondence email address relative to any merchants that are routinely patronized by the user. In a variation of this embodiment, the RA email address may be a temporary address that only works for the current round of transaction. If the user is a new client, the user may submit the RA email address to the merchant on the first transaction. It may be noted herein that SW controlling the handling of user email directs all merchant receipts received at the server to be aggregated, such as in a single in box folder and then forwarded to the cloud server for processing. This does not preclude any other important emails from being processed by the RA email domain. More particularly the user may use the RA email address for normal IMAP email correspondence.

The SW 115 of FIG. 1 may include the email domain service for users and the email server may be a dedicated server in the domain of the cloud wallet service. The SW may identify electronic receipts from transactions by recognizing various bits of information that appear in the receipt data. For example, the receipts include date and time of a transaction, a merchant name or logo, an POS terminal address, Geo-location of the transaction, and the last four digits of an account used to pay for the transaction.

The email logic may in one embodiment isolate all of the incoming messages containing receipts attached including those with embedded receipts from emails coming into the server for a client and may store the emails containing receipts for the SW to mine for the receipt data. The receipt data may be sorted categorized and archived the user, the receipts accessible as part of account history. In one aspect the email server and cloud server are on the same network server.

Once the emails containing the receipts are prepossessed and archived at the cloud server, the cloud server may notify the user over the network that a receipt or receipts are available for review and access at step 906. Notification may be received by the thin client application 120 running on the user's mobile phone. In that event, the user may click on the notification and download a receipt for review in screen 119 and may have access to tools for further describing a receipt, flagging a receipt for tax deduction, and so on. A user operating mobile phone 122 aided by SW 120 may access any electronic receipt from the cloud service at any time. The process may end at step 907.

In a preferred embodiment of the invention, the RA email system is a dedicated system contained entirely within the domain of the cloud wallet service. However, in one embodiment SW may be provided to users to modify existing email capabilities of an IMAP account or desktop versions of well-known programs like Outlook Microsoft, Google, and so on to add the function of identifying electronic receipts resulting from transactions made by the user and isolating those from other emails and forwarding those on the cloud service. In this way, the user does not have to worry about losing misplacing or not having immediate access to any electronic receipts the user has made that were aggregated by the system.

### Receipt Aggregation from QR Code Capture

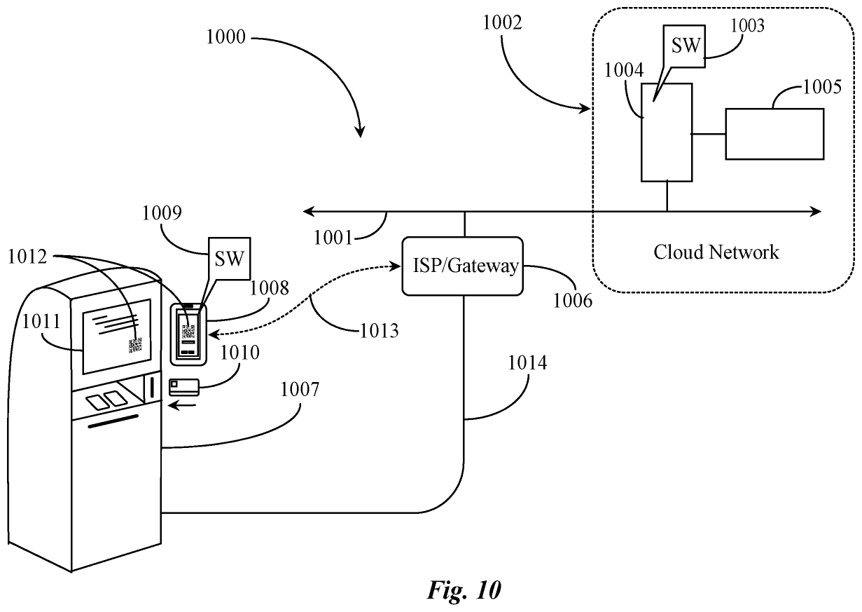

FIG. 10 is an architectural view 1000 of a communications network supporting receipt capture and aggregation via quick response (QR) code according to an embodiment of the present invention. Communications network 1000 includes network backbone 1001. Network backbone 101 may represent all lines, equipment, and access points, routers and gateways that make up the network as a whole including connected sub networks. Communications network 1000 may be an Internet network or another wide-area-network (WAN) without departing from the spirit and scope of the present invention. There are no geographic limits to the practice of the invention.

Backbone 1001 supports a network cloud labeled cloud wallet service 1002. Cloud wallet service 1002 may be adapted by a financial mobile cloud wallet service company to store credit card data, debit card data, and other electronic card or account data, for a mobile user, represented herein as user phone 1008 having a dynamic transaction card 1010 that may be programed with a selected set of card transaction data, for example, to make a specific transaction.

Cloud wallet service 1002 includes a server 1004 supported by back bone 1001 running a software (SW) application 1009 and coupled to a data repository 1005. SW 1009 may be a cloud wallet application for a dynamic transaction device like card 1010 or another device used to interact with a sales or banking terminal (electronic machine/network node). Data repository 1005 may include user identification and profile data, user accounts data, financial history data including transaction history, cloud wallet account data and the like.

Access to communications network backbone 1001, which may represent the Internet in one embodiment, may be through an Internet service provider (ISP)/access Gateway 1006 supported by backbone 1001. A carrier network is depicted as a dotted line 1013 between ISP/Gateway 1006 that enables communications including wireless communications to be bridged onto communications network 1000 through ISP Gateway 1006 and mobile phone 1008 running a software application (SW) 1009.

Carrier network may be a wireless 5G network or similar mobile network that user-operated mobile phone 1008 may use to access the network and practice local and long-distance communications using the representative mobile telephone. Mobile telephone 1008 may be Bluetooth™ enabled. SW application 1009 may be adapted as a thin mobile SW application including a network connection and browsing ability that may locally display information screens in display on mobile phone 1008.

The user operating mobile phone 1008 may be present at a business domain that may be a service site, restaurant, retail establishment, parks service, rental agency, lodging, or any venue that a user may patronize to buy a product or service. In this embodiment, a point of sale (POS) machine or terminal 1007 that takes, at least, credit and debit cards for satisfying financial transactions made by a user operating mobile phone 1008.

In this embodiment, a user operating mobile phone 1008 may have a dynamic universal transaction card 1010 that may be electronically associated to a funding source account and may be accepted by terminal 1007 to pay for goods or services. In a preferred embodiment, user operating mobile phone 1008 may transmit account data to card 1010 from the mobile telephone while running SW 1009 and Bluetooth™ wherein the card 1010 is Bluetooth™ enabled to at least receive the account data (card number) wherein the account data represents an account that user operating mobile phone 1008 has subscribed to as represented in cloud wallet service 1002.

It is noted herein that the components described above are the same or similar to counterparts described further above in FIG. 1 relative to architecture for receipt capture in general. Some components of FIG. 1 such as online retail and financial institution architecture are not described herein but may be assumed present in most embodiments without departing from the spirit and scope of the invention.

A user operating mobile phone 1008 may have several different accounts represented in cloud network 1002 and dynamic transaction card 1010 may be loaded with any of the user's account data to use that account to pay for goods or services during a transaction. SW 1009 on mobile phone 1008 enables the user to interact with cloud network 1002 just before using card 1010 at POS terminal 1007 so that the user may determine which of several accounts might be imprinted or sent to card 1010 for use as a device representing that account.

Cloud wallet application SW 1009 may embody information display screens on mobile phone 1008 that may be part of the interactive interface available to the user operating mobile phone 1008 to load card 1010 with a card number, security code, and other pertinent data so the card may be used as a card of a selected account. Any new account data that the user loads onto card 1010 may overwrite any previous account data on the card memory.

In a preferred embodiment, SW 1003 executing on server 1004 in cloud wallet service 1002 is adapted to at least receive and file electronic receipts on behalf of the active user operating mobile phone 1008 in near real time. Card 1010 may be used as the transaction device to pay for one or more transactions at POS terminal 1007, the card written to by mobile phone 1008 executing application 1009 in broad respect while card 1010 represents a particular account listed in cloud wallet service 1002.

In one embodiment, a user operating mobile phone 1008 aided by SW 1009 may capture a quick response (QR) code 1012 generated by POS terminal 1007. In this embodiment, the POS terminal generates a receipt in the form-package of a QR-based or derived code 1012 (code variations exist) that may be displayed on a POS screen 1011 in view of the user. In this embodiment, QR code 1012 is displayed on the application screen of mobile phone 1008 after it has been captured using a QR code scanner/reader native to the mobile phone. SW 1009 leverages the camera scanning capability of phone 1008 to enable QR code capture from screen 1011 or from a printed element (not illustrated) like a contract, an advertisement, or other content-printed paper.

SW 1009 may include a SW extension to an application on mobile phone 1008 like a QR scan capable camera application. In one embodiment, QR code 1012 is a dedicated vehicle for carrying only transaction receipt data. In one embodiment, QR code 1012 may include other data along with transactional receipt data like advertisement data, shipping data, product tracking information, product insurance, registration data, rental agreement data, or other contractual data.

In one embodiment, dynamic card 1008 may be used to conduct a transaction that will produce a receipt generated in the form of QR code 1012. In one embodiment, dynamic card 1012 may send at least a wireless data notification, a push notification command, or signal over the wireless link to mobile phone 1008, for example, by Bluetooth™ wireless network. For example, dynamic card 1008 may communicate via Bluetooth™ or other wireless protocol to mobile phone 1008, the data notification, command, or signal, verifying that a transaction has been completed at POS terminal 1007 and a QR receipt is forthcoming, for example, in display on the POS.

Moreover, the communication may, in one embodiment, function as a direct command to execute a camera application QR scanning feature resident on mobile phone 1008 using SW 1009. In another embodiment, the communication may be a simple notification with sound, flash or other feedback that may prompt the user operating mobile phone 1008 via a pop-up or other visual notification appearing in application screen that a transaction has occurred and a QR receipt like QR code 1012 is forthcoming and may be electronically captured.

In one embodiment, QR code 1012 is generated at POS terminal 1007 after a transaction is conducted and wherein the dynamic card 1008 communicates a signal triggered by the read operation at the POS terminal, the signal processed by the cloud wallet application causing a camera application, via application extension, to execute automatically on mobile phone 1008 to ready the camera or QR code scanning device to capture/scan QR code 1012 as it is displayed on screen 1011 of POS terminal 1007.

A QR code reader may be employed, for example, during QR scan to render the electronic receipt legible and, in one embodiment, somewhat editable in display on screen 1011. In another embodiment, the user operating mobile phone 1008, wherein the mobile phone and the POS terminal are enabled for near field communication (NFC), may be using the mobile phone without an intermediate transaction device to transfer the correct wallet account information at the POS NFC interface to conduct a transaction. In this embodiment, the generated QR code 1012 carrying receipt data may be transferred through NFC to mobile phone 1008 without departing from the spirit and scope of the invention.

In still another embodiment wherein the POS terminal 1007 is not connected to a printer and has no display capability, a QR code carrying receipt data may be captured electronically from a user's email account or messaging account (display enabled) if the merchant electronically mails media or graphics or text to an end device controlled by the user.

In the above scenario, the cloud wallet application may monitor the user's email or messaging account and may grab or capture the QR code 1012 generated and sent by a merchant as an attachment to the email or text message. In a variation of this embodiment, the wallet application may be further enhanced with a SW extension that allows the application to use a screen scraping utility or snap-shot utility to capture a QR code embedded in display (but not attached) in an open email window on the user's mobile phone where the wallet application may be further enhanced with a capability to open email messages.

In this architecture, a user operating mobile phone 1008 may capture and read QR code 1012 and may display the data in template form on the application screen while running SW 1009. The template form may include spaces for all pertinent data for a type of transaction receipt. In one embodiment, there may be multiple template types available to a QR reader to accommodate different types of receipts, for example, a product receipt or a service or rental receipt. In another embodiment, accompanying important documents may also be included with the transactional receipt data like service contracts, rental agreements, operational instructions, registration forms/links and the like.

In one aspect of the invention a user operating mobile phone 1008 may capture QR code 1012 from POS screen 1011 onto mobile phone 1008 running application 1009. Once on the mobile phone, QR code 1012 may be first displayed as a machine-readable code or not otherwise altered. The application may provide in this aspect, an option to the user to reconstruct the QR data into human readable form. The user may reconstruct the image in somewhat editable format wherein tools like redaction features erase or mask might be available as well as tools for adding any meta data or digital associations with the reconstructed receipt data. The user may then send saved receipts to cloud wallet service 1002 through ISP/Gateway 1006 via wireless carrier 1013 where those receipts might be archived in cloud storage 1005 where they remain available for access.

In another aspect of the invention, after generating a QR code (1012) carrying receipt data as a result of a user transaction at the POS, POS 1007 may send the generated QR code 1012 directly to cloud wallet service 1002 via network access line 1014 and through ISP 1006 onto backbone 1001 and server 1004 aided by SW 1003. This aspect, the QR code is reconstructed into human readable form at server 1004 aided by SW 1003 and artificial intelligence (AI)-assisted receipt characterization processing may occur as may be made permissible by the user. Then the cloud wallet service 1002, more particularly server 1004, may push notification to the mobile phone 1008 of the user over backbone 101, through ISP/Gateway 1006 and onto wireless carrier 1006, the notification informing the user that one or more receipts are ready for task or modification by the user, the amendments made by the user and saved for archive by the service.

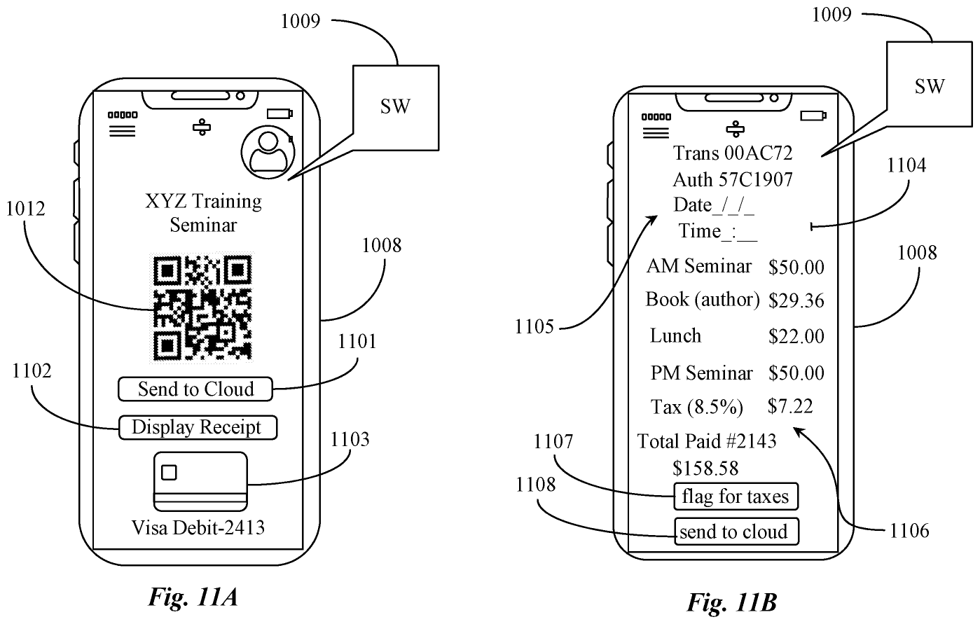

FIG. 11A is an elevation view of mobile phone 1008 displaying a receipt in the form of a scanned QR code. In this embodiment, the transaction has been conducted and the POS terminal has generated QR code 1012 and displayed it for capture, and Phone 1008 has captured same and is in the process of displaying same in application 1009. Application 1009 may be a thin client application downloaded from the user's cloud wallet service. The application screen may display the scanned in QR code 1012 along with at least a merchant logo for differentiating the code from another code.

Application 1009 may, in one embodiment, display the account iconic identification 1103 of the wallet account selected and used in the transaction that produced the QR code carrying the receipt data. These types of associations may be made by the system without requiring reconstructing the receipt data or other data included in the code. In one embodiment, a user may select send to cloud option 1101 to forward the captured and displayed code to the wallet service.

SW 1003 may use the meta data specifics about QR code 1012 to sort and basically categorize the code for archival in cloud storage 1005 without needing to reconstruct the QR code for human legibility. In one embodiment all of the receipts are stored as QR codes if so generated. In such an embodiment, a user may be required to reconstruct the receipt from the QR code locally before viewing it in text.

In one embodiment, SW 1009 includes an option 1103 for reconstructing and displaying the data carried in the QR pattern for human reading and for audio synthesizing to electronic speech (if equipped) for playback. Selecting display receipt 1102 cause the QR application to reconstruct the QR data into form for display of at least a receipt listing all of the important data of the transaction covered.

FIG. 11B is an elevation view of mobile phone 1008 of 11A displaying a receipt containing data reconstructed from the QR code of 11A. In this view, a reconstructed receipt 1104 is displayed in the application screen as a result of the user interacting with the display receipt option 1102 of FIG. 11A. Receipt 1104 includes at least incident or event data 1105 like a transaction number, an authorization number, a data, and time of the transaction. A receipt content body 1106 may include the descriptive data and pricing paid or charges inferred. In this example, the user attended a training seminar, perhaps as part of a work or business function.

Receipt body 1106 breaks down what the user paid for over the entire seminar which is included in one transaction. The items listed in order include an AM seminar, a Book purchased during or after, followed by a lunch the user purchased, followed by a PM seminar, and accumulative tax for the book and lunch items. The receipt total is $158.58 taken from wallet account having the four last digits of the account number revealed as 2413. Additional data may be provided in the receipt data that is displayed for the user like merchant identification or come back advertising discounts.

In one embodiment the electronic receipt is one of multiple documents that the user has displayed for human reading. In this case the user may display the receipt and scroll to see other pages containing other data. SW 1009 may include a flagging option 1107 for the user to flag the receipt for tax deduction. Selecting this option may mark the receipt for tax flagging and open other options made available to ad meta data, add characterization, add text notes, add a hyperlink etc. The added data may be mapped to the receipt data and stored in human readable bur encrypted form.

In one embodiment, the wallet server aided by SW may generate a second QR code carrying the data of the first pattern and the new data added. In this form the new code may be stored in machine readable form and held in an encrypted state. In one embodiment, a send-to-cloud option 1108 is provided like option 1101 of FIG. 11A enabling the user to send the data to the cloud wallet service 1002 through the Internet connection and carrier network of the phone.

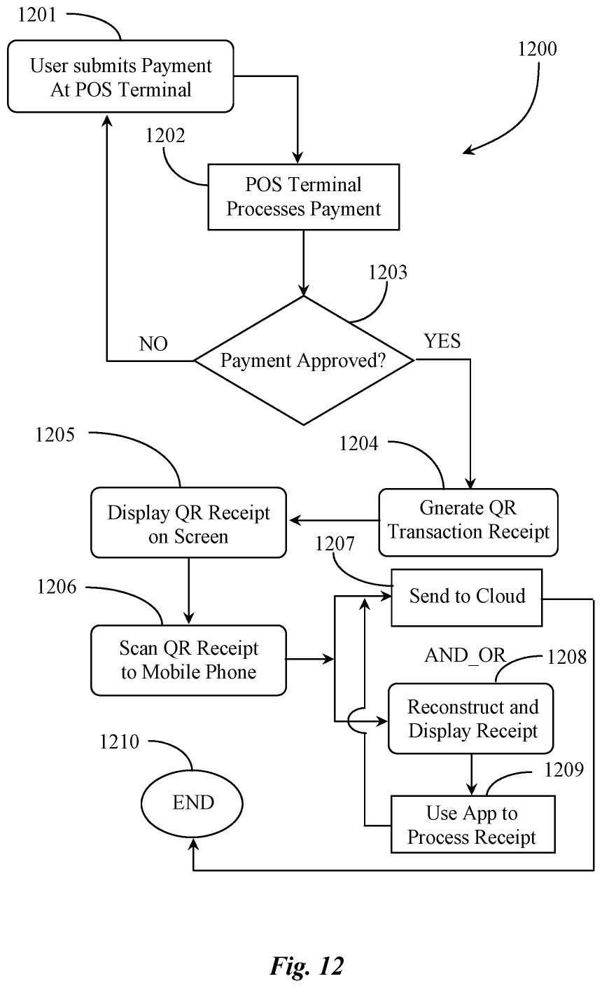

FIG. 12 is a process flow chart depicting steps 1200 for receipt capture and aggregation according to an embodiment of the present invention. At step 1201, a user submits payment to a POS terminal during a transaction. At step 1202, the POS terminal processes the payment submitted in step 1201. The user may pay with a card, a wearable transaction device like a watch, or with the mobile phone hosting the client application of the cloud wallet service or money pay application.

At step 1203, the POS terminal monitors to determine if the Payment made was approved for the transaction. If the payment was declined or otherwise not approved at step 1203, the process loops back to step 1201 where the user may try again with another payment account. If the payment is approved at step 1203, the POS terminal may generate a QR code representing at least the transaction receipt at step 1204. In this aspect, the POS terminal has a display screen that the user may see and interact with.

At step 1205, the POS terminal may display the generated QR code hosting the receipt data on the POS display screen. At step 1206, the user may scan the displayed QR code into the mobile phone through the client application leveraging a QR scanner/reader on the phone. In one embodiment, the user's card or wireless transaction device may send a wireless signal, notification, or command to the user's mobile phone when the transaction is being conducted wherein the signal notification or command results in execution of the client application if closed and execution of the QR scanning application used to scan the QR code in step 1206. However, it is not required to practice the present invention but is a convenience to the user.

The process branches where the user has two options once the QR code is lifted from the POS terminal display. One option is sending the QR code to the cloud wallet service at step 1207 without reconstruction of the receipt locally. The other option is to reconstruct the receipt data for display on the user's mobile phone screen in the thin client application screen. In option 1207, the wallet service may receive the code from the user and process it according to the meta data already known about the transaction the merchant and the user's account used to pay for the transaction. After step 1207, the process may end for the user at step 1210. The cloud service may take care of the rest of the receipt processing and may send a push notification to the user after it is ready for access by the user.

If the user wishes, the QR code may be reconstructed relative to at least the receipt data and displayed on the user mobile phone in the client application as a human readable receipt in step 1208. At step 1209, the user may process the receipt for any allowed tasks such as tax flagging, merchant name redaction, categorization (business/account) send to third parties, add meta data, add to list, etc. in step 1209. The user may then send the process may loop back to 1207 where the receipt (in legible form) and any added meta data to the cloud wallet service for archiving on behalf of the subscribing user. The process may then end at step 1210 for the user. It is noted herein that receipt data accrued by a user operating a mobile phone with the thin client application may be provided in batches to the cloud wallet service whether in QR code form or in reconstructed receipt form.

In one aspect of the invention, the user may lift a generated QR code off of a paper medium printed at the POS terminal if there is no active display screen. In one aspect a transaction may be complicated like a loan document signing, a contract signing, a rental agreement, a blanket purchasing agreement, etc. These types of transactions may require more data to be loaded into the QR form than just the accounting or receipt data. The standard QR code form may hold several pages of text. There is a rectangular version of a QR code block that may hold more data and may be incorporated as well. In one aspect of complicated transaction, a merchant or service broker may generate more than one QR code as required for data rate wherein one QR code may hold receipt data and another QR code may hold associated contractual data. All of the QR data may be reconstructed locally or at the wallet service and may be rendered accessible for review edit, modification, and so on.

### Management of Value Codes and Notification for Use

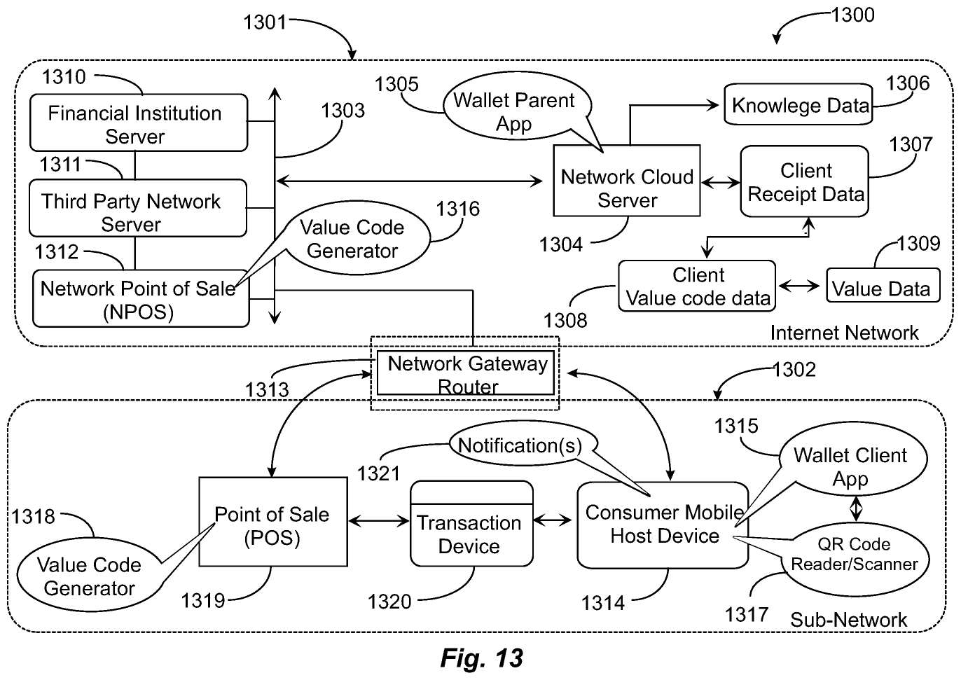

FIG. 13 is a block diagram depicting a network architecture 1300 supporting value code management and notification according to an embodiment of the present invention. Network architecture 1300 represents a wide area network and any sub-network connected thereto for example the Internet network 1301 and a sub-network 1302 connected to network 1301 via a network gateway or router 1313.

Sub-network 1302 may include one or more sub-networks having connection to network 1301 through gateway or router 1313. Examples of sub-networks may include wireless carrier networks for mobile communications and Ethernet local area networks (LAN) wired or wireless. Network 1301 includes a network backbone 1303 supporting among other nodes a network cloud server 1304. Network cloud server 1304 is programmed to service clients according to a wallet or money pay application similar to cloud wallet service 1002 introduced in the description relative under FIG. 10. above.

Server 1304 hosts a cloud wallet parent application 1305. Wallet application 1305 may provide a client wallet application for download and install on their mobile devices for example, on their smart phone devices. Server 1304 has connection to one or more data repositories adapted to hold client data including a repository or section there of holding client receipt data 1307. Receipt data 1307 may represent any captured receipt data that has been uploaded to server 1304 from a client operating from a connected sub-network like network 1302.

A client of cloud wallet service 1304 may operate a consumer mobile host device like a smart phone, for example, that may run a client wallet or money pay application 1315 as a thin browser-based client that has permission to access and use one or more features or applications on the client's phone. Client application 1315 allows a client to load a transaction device with card data from the wallet service for use in transactions at points of sale. The service also may provide a command or notification depending on method for capturing the receipts accrued by the client during periods of transaction, the receipts categorized and or flagged for tax purposes and archived for the client. Client receipt data 1307 represents such an archive.

Receipt data held in repository 1307 may be electronic transaction records, like receipts for goods and services purchased by or rendered to the client. In one embodiment where a receipt may be represented by a QR code, the QR code receipt may be held in the same database as the electronic alpha/numerical character receipts. An electronic receipt displayed as an alpha/numerical character receipt may further include one or more value codes or offer codes that are in the form of one or more scan-able and readable bar codes or QR codes printed along with the receipt data. A Receipt expressed as a QR code may further include additional offers, discounts, points, or other value items available to the client that made the transaction. This value data code may be represented in the same code structure as the receipt data.

In this embodiment, client value code data 1308 may be isolated at the server from the alpha numerical receipt data and the human readable value data may be lifted from the code for display to clients through the thin client application 1315 running on mobile host device 1314. Network Cloud server 1304 has connection to a knowledge base repository 1306 adapted to contain knowledge data about clients to an extent that clients of the service have granted permission.

In one embodiment, knowledge about the client is leveraged to help determine if the service should generate and send notifications to the client that may alert the client in a timely or advantageous manner of available offers, discounts, or promotional deals that the client has aggregated through the receipt capture activity and perhaps by other means as well such as direct uploads of offers, promotional codes, or discount codes the client has captured and uploaded directly to the service through client wallet application 1315 for archiving. Knowledge data 1306 may be held securely for each individual client and may include on-line client generated content like browsing history and search result data. Knowledge data 1306 may include wallet account use and transaction history. Knowledge data 1306 may include client schedule data and real time client location data.

Knowledge data may include travel history including the locations and descriptions of businesses routinely patronized by the client.

A client operating mobile device 1314 running wallet client application 1315 may typically use a dynamic smart card as a transaction device 1320 to complete a transaction at a point of sale (POS) terminal 1319. In a variation of this embodiment, the host mobile device may also be the transaction device. In still another variation of the embodiment, a wearable transaction device can be used. In the case of separate transaction devices, the host device may write to the transaction device using a wireless connection protocol like Bluetooth™.

Network 1301 includes backbone 1303 supporting at least a financial institution server (account issuer) 1310, at least one third-party network server like an email server 1311 (potential source for receipts) and at least one network-based POS (NPOS) server like a secure checkout server 1312. All three types of nodes may be integrative to the overall process of building a value data portfolio for a client.

In an embodiment of the present invention, value data for a client comprises any proposal or offer to save money during the process of transacting. Value data is made available to clients through printed receipts, electronically generated receipts, or through separate coupons. The value data is typically quantified in a printable or displayable code such as bar codes or quick response codes that may be scanned into a system from printed media or from a display screen and made part of a current transaction or future transaction. It is an object of the present invention to provide a service accessible to clients through interaction with cloud server 1304 hosting parent wallet application 1305. The interaction, in a preferred embodiment, takes place between the consumer mobile host device 1314 running cloud wallet client application 1315, and cloud server 1304 running cloud wallet parent application 1305.

In practice of the invention, a user operating mobile consumer host device 1314 may conduct a transaction with a POS terminal or network node. In this example, the user operating host device 1314 is using a dynamic transaction card 1320 at a physical POS terminal 1319 to complete a transaction wherein the account card number may be requested from cloud server 1304 and written to transaction device 1320 before the card is read at POS terminal 1319. A goal of the user is to capture a receipt of the transaction and send the receipt to the cloud wallet service to be added to an aggregation of receipts stored for the user.

POS terminal 1319 is capable of generating value data for the client using a value code generator 1318 such as a QR code generator or a Bar code generator. It may be assumed that POS terminal 1319 is also capable of generating a receipt. Referring now to FIGS. 11A and 11B, the POS terminal may generate a receipt in the form of a QR code that includes all of the pertinent receipt data. Referring now back to FIG. 13, value data targeting the client may be included along with receipt data in a generated QR code and is included in the code structure, which may present data horizontally and vertically in the same code image. In this embodiment, the receipt and the value data are generated as a QR code that may be printed out for the client or may be displayed on a POS screen for the client who may capture the receipt into consumer host device 1314 aide by application 1315. Application 1315 may host or control a QR code reader/scanner application 1317.

When the POS terminal 1319 reads the data on card 1320, it makes connection to the financial institution server 1310 to verify funds and approve or deny the account data presented. A capture event for a receipt may be prompted by server 1304 running application 1305 through a running wallet application 1315 on host device 1314. Wallet application 1315 may enable display of the captured QR code data in alpha/numerical characters for the client to read. The client may of course sync with the service to upload the saved QR code receipt and value data to server 1304 for processing with the aid of application 1315 on behalf of the client.

In another embodiment, POS terminal 1319 generated an alpha/numeric transaction receipt but includes value code data on the receipt in the form of one or more bar codes or QR codes. In this embodiment, the receipt data may be printed or displayed including the coded value data for capture by the client. Receipt data may also be emailed to consumer host device via third-party server 1311 (email server). In that case, the client operating mobile device 1314, for example, a smart phone may receive and display emailed receipts and capture the data using a wallet application-controlled capture utility.

In still another embodiment, the client operating mobile host device 1314 may connect to a network POS node like NPOS 1312 to conduct an online transaction where the account data is typed into a form. In this case, NPOS server 1312 may use a value code generator 1316 to generate value code expresses in the form of QR codes or Bar codes. It is noted herein that POS terminals like terminal 1319 may forward value codes generated by advertisers and other third-party providers to clients wherein the value code is added to generated receipts or coupons printed with those receipts or where the value code is included in a receipt generated and expressed as a QR code. Likewise, the same is possible with NPOS node 1312. Value code generators are not absolutely required at the level of POS terminal or node in order to practice the present invention. Once the value code is captured and transferred to cloud wallet server 1304, the server may process the data and store the data on behalf of the client. The client may be relieved from browsing through hard paper or coupons to find deals they can take advantage of when they are transacting or to partake in offers they have been presented with.

Parent wallet application 1305 running on server 1304 may process data for a client and may separate value data from receipt data and hold the value data for the client while the value data is useful to the client meaning that the value data has not yet expired. Some value data may not include an expiration and therefore, may be useful to the client on an ongoing basis.

It is a goal of the invention that parent application 1304 has a capability of disseminating the value code aggregated by the client and presenting the client with value data notifications at opportune times or in a fashion that suits the client in real time. Therefore, the parent application 1304 may upon client permission, access data generated by the client like browser history, search result data, shopping history, and other knowledge to aid in prioritizing value data to the client, and to determine opportune times to send a value notification such as notifications 1321 on consumer mobile device 1314 running wallet client application 1315 to a client to alert the client of currently available values they can redeem when they are shopping, traveling, searching for information, and so on.

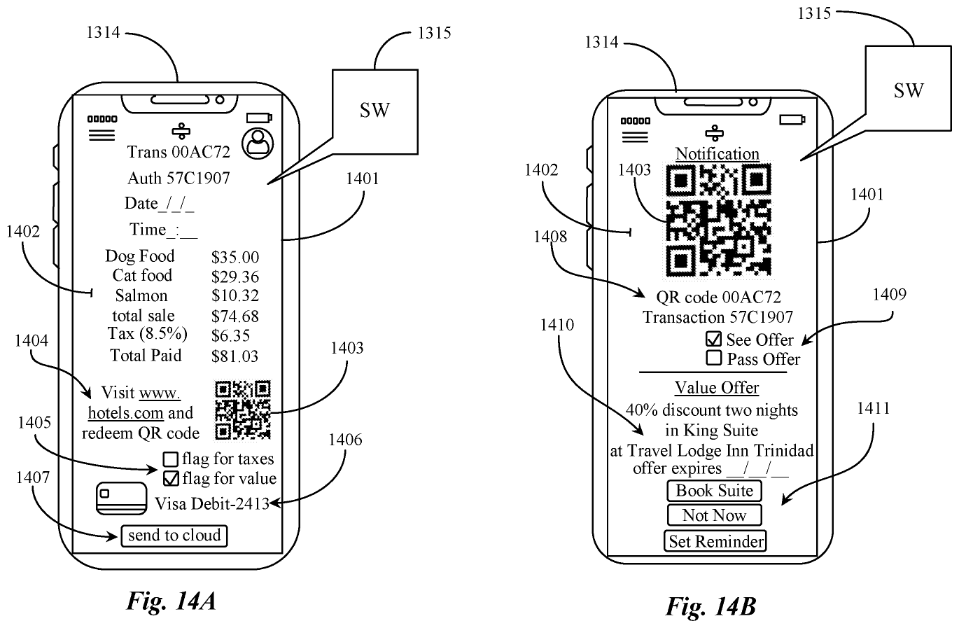

FIG. 14A is an elevation view of a device application display screen of a receipt captured including a value code according to an embodiment of the present invention. In this embodiment, mobile consumer device 1314 is a smart phone running client wallet application 1315. It may be assumed that wallet application 1315 is a browser-based thin client application that may display information on a display screen 1401 embedded in an interactive information page 1402 using appropriate markup language.

Interactive screen 1402 depicts a captured receipt including a transaction number, authorization number, transaction date and transaction time. The receipt accounts for items purchased by the client and is displayed in alpha/numerical characters for the client. In this embodiment, the receipt includes a value QR code 1403 displayed for the client below the accounting for items purchased. QR code 1403 is associated with a third-party online website 1404 which is an advertiser for one or more hotel chains. In one embodiment, a client may expand QR code 1403 by clicking on it and wallet application 1315 may decrypt the value code into alpha/numerical characters for display in place window or on an added information page. If the client desires, the client may navigate to the website link and redeem the value code, which presumably is a discount on a hotel service.

The receipt information screen 1402 includes two interactive flag or marking options 1405, which are to flag for taxes and to flag for value. In this case, the client has only flagged the receipt for value because of the presence of QR code 1403. Information screen 1402 includes identification of the wallet account that was used in the transaction to generate the receipt for capture. Information screen 1402 includes an interactive submission button for transferring the receipt and the value code to the cloud server to be managed in the cloud service on behalf of the client. In one embodiment, the client may decrypt QR code 1403 to see the value offer and may take advantage of the offer immediately before uploading the receipt to the cloud. In another embodiment, the client is not ready to take advantage of the value, so the receipt is marked to include the value data.

In one embodiment, the receipt and the value data are generated in the form of a QR code like code 1403 that may be the only item in display on information screen 1402. In that case, the client has capability to expand the QR code (reader) to see all of the alpha/numeric characters comprising the receipt data and the value offer and identification of the redeeming site.

FIG. 14B is an elevation view of an application display screen of information about the value code of FIG. 14A. In this embodiment, the interactive information screen 1402 depicts a notification sent to phone 1314 and received by application 1315. The notification includes the image of the original QR code 1403 along with identification of the original transaction and QR code number. The notification received from the service may be a triggered event based on knowledge of client activity, client need, or client-convenient opportunity. For example, the service may have access to search content or web activity indicating the client may be looking for lodging. The service may locate the value offer 1403 and send it in a notification informing the client of the available offer.

Interactive options 1409 may be provided in screen 1402 for the client to read the offer in alpha/numeric characters (expand offer to see details) or the client may pass on the offer. In this embodiment, the client has selected to see the offer (expand QR code value data) and the information is displayed further below in screen 1402 as information 1410 explaining the available offer. The information may include action links 1411 for booking, for delaying (not now) and for setting a reminder to take advantage of the offer (booking). Notification screen 1402 may include more than one related value offer if more than one is available to the client.

In this embodiment, QR code 1403 is a value offer from a third-party provider working with the business that generated the client transaction. In another embodiment, value data is pertinent to location, for example discounts on next purchase, point earned for purchase, deals available at the location when the client is there, etc. GPS location of the client may be a trigger used by the service to send a notification containing value data to the client. The original QR code or Bar code may be displayed on mobile phone 1314 and scanned by a value code reader at a POS terminal. Moreover, the code images may be submitted to online POS nodes and redeemed online such as for booking rooms, reserving tables at restaurants, reserving rental vehicles, and so on.

In this way, the cloud wallet value code management service of the present invention works to provide organized fingertip access to available values and offers to clients having their value code data saved and managed for them by the service. The client may receive notifications at any time the service deems that sending a notification might be of benefit to the client including notifying the client of value data and offers that will expire and be purged from or no longer be maintained in the cloud service.

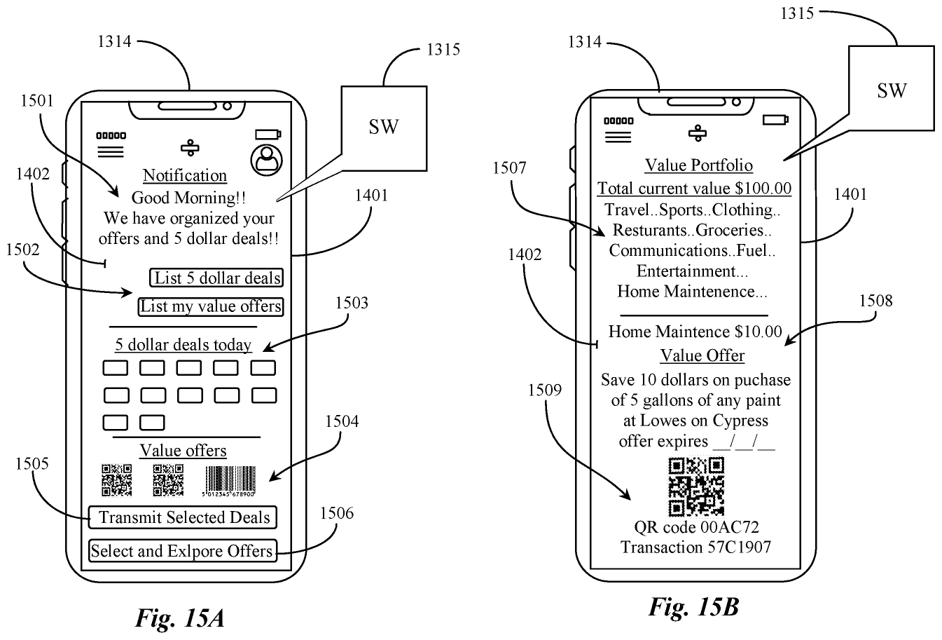

FIG. 15A is an elevation view of an application notification presenting list information of available deals and value offers. In this embodiment, information screen 1402 displays a received notification that aggregates several deals listed as deals 1503 and as value offers 1504 onto one information page that a client may interact with. A message may accompany the notification such as message 1501 explaining the presence of the information in the interactive screen 1402. In this embodiment, the client may be located at a grocery's outlet on a day of the calendar where deals previously communicated to the client in receipts or by other media are available. For example, a day Monday where a store routinely patronized by the client provides weekly deals the client may take advantage of if the client is shopping there that day.

Interactive options 1502 may be provided below the notification message 1501 enabling the client to list the value deals 1503 and any value offers 1504 which might have been aggregated from receipts the client has previously captured. In one embodiment, a client may scan in value codes for five dollar deals prior to arriving to the shopping center to take advantage of those deals as they are planned in advance. The service then transfers the deals back to the client so the client may use the phone 1314 to identify and then locate the deals the client wants to take advantage of on that day. Other deals may have more than one day time to live where the client may not use the deal but may pass leaving it in management in the cloud.

In one embodiment, value offers 1504 may be displayed at a POS terminal to redeem the offer. A client may also expand each offer 1504 to see the details in a pop-up screen or in a new window, or in the same screen if room is available. In one embodiment, an interactive action button is provided for transmitting the original value codes (bar codes or QR codes) of the selected deals to the POS terminal in the process of transacting with that terminal to take advantage of the deals. Therefore, a human operator is not necessarily required to physically scan codes from coupons the client must separate and hand to the person. Instead, the POS terminal may capture the codes off of display on the client's mobile phone 1314 in application 1315.

In another embodiment, where a wireless dynamic transaction card is used, the client may be able to send the original value codes for the selected deals to the transaction card along with the payment account information wherein the POS terminal may take and approve payment after the deals have been applied to the total amount. In another embodiment, deals 1503 may be squired by the cloud wallet service from the store merchant account when the store creates them in an arrangement that saves time and money for both the client and the merchant. A client may click on and see the alpha/numeric data relative to value offers 1504 and may also transmit or display for capture the original codes to redeem the offers by selecting interactive action button 1505.

In this embodiment, it might be assumed that the value offers 1504 displayed along with five-dollar deals 1503 might be redeemed at the same general location the client might be patronizing. If a merchant is close to different stores next to one another, the value offers 1504 may be put in the notification because they were simply available to the client at merchant locations reasonably close to the outlet the client is patronizing. A client may select option 1506 to select and explore value offers 1504. In one embodiment, a client may select individual ones of the displayed value offer codes 1504 to expand and explore.

In one embodiment, a client may select all of the deals that they will redeem as they are loading them into a cart for check out and then refresh information screen 1402 to remove the unselected deals from the interface. It is important to note also that value deals 1503 and value offers 1504 may, in one embodiment be redeemed during online shopping activity wherein the items will be delivered and where value offers are redeemable offers that may apply a discount or credit to be reserved for a future date like a discount on hotel suite rates, etc.

FIG. 15B is an elevation view of an application display presenting current value portfolio data and navigable categories. In this embodiment, parent wallet application 1315 running on host device 1314 manages value data for a client and may follow a general process of categorizing value data and quantifying value data. A client working in application 1315 may order a value portfolio view or dashboard style screen 1402 that displays value portfolio data 1507. In this view, value data 1507 includes a total monetary value of current available deals and offers. Data 1507 may also display interactive value data categories representing categories under which deals or offers apply.

Categories having related value deals and or value offers may include travel, sports, clothing, restaurants, groceries, communications, fuel, entertainment, and home maintenance. Many other categories may be added or subtracted. A client may browse categories and click a category to see deals and offers under that category. It should be noted that other types of dashboard views showing portfolio value data may be ordered, for example, deals and offers sourced from transactions performed from a specific account represented in the cloud wallet service. A client may also order views relative to expiration dates of deals or offers. For example, a few of deals and offers set to expire in 48 hours might be ordered. The service may also notify the client when deals or values are close to expiration wherein the client may partake of the still current deal or offer or pass and let the deal or offer expire.

In this view, a client has selected category home maintenance to reveal a $10.00 value offer 1508 on the purchase of 5 gallons of paint at a specific hardware store and location including the expiration date of the deal. Offer 1508 also includes a QR code image 1509 for redeeming the offer, the image including the code identification and original transaction number that generated the offer and was captured along with the receipt for the transaction that occurred. In this view, the category home maintenance has a 10-dollar value and shows only one associated offer. However, clicking home maintenance may reveal several value offers a client may select from.

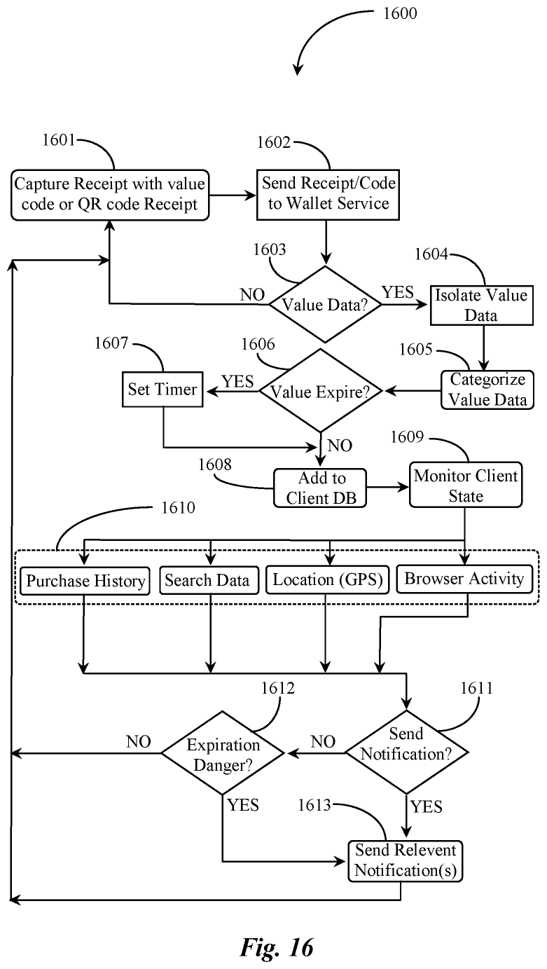

FIG. 16 is a process flow chart 1600 depicting steps for managing value data and notifying a client of available offers in an activity-relevant manner. At step 1601, a client captures a receipt with a value code in the form of one or more bar codes or one or more QR codes. In one embodiment, the receipt data and value code are written into a same QR code. The capture event of 1601 may be a result of a command or notification from a wallet service received by the client operating a mobile communications device running a client application.

At step 1602, the client may send the captured receipt/value code to the cloud wallet service using the wallet application on the mobile device of the client. A step for displaying and flagging the receipt may be provided in between step 1601 and 1602. At the cloud wallet service, the cloud server running the parent wallet application receives the data from the client and determines at step 1603 whether there is value data to be aggregated. In one aspect of the process, a client may flag for value data as previously described further above. In one aspect the client may transmit a QR code receipt wherein the cloud wallet parent application discovers value data embedded in the code along with the receipt data.

If at step 1603, there is no value data on a receipt or embedded in a QR code receipt, then the process may resolve back to step 1601 for the next receipt captured. If there is value data present in step 1603, the wallet application may isolate the value data from the receipt data at step 1604. At step 1605, the wallet application may categorize the value data by consumer category or by source account or by another method. Step 1605 is not required to practice the invention but may be included for client convenience.

At step 1606, the wallet application may determine if the value deal or offer has an expiration date or time to live. If at step 1606, it is determined that the value data has no expiration, the process moves to step 1608 wherein the value data is added to the client database. Value data may be stored in the form of the original bar code or QR code. The value data may also be stored as alpha/numeric characters. Preserving the bar code or QR code enables the wallet server to transmit the codes to the client device for display and scan at POS terminals.

If at step 1606, it is determined that the value data has an expiration, the wallet application sets a timer associating the timer to the data to track the time to live (TTL) of that deal or offer in the system. After tracking is live that value data is added to the client base data in step 1608. At step 1609, the client state of activity may be monitored and analyzed against that client's value data. Monitoring client state activity may include accessing client browser history, purchase history, data search content, wallet account history, etc. based on client permission given to the service. Other client states 1610 may also be periodically or continually monitored like client GPS location.

The wallet service determines at step 1611 after comparing client state with current value data content if there is an opportune time to send a notification to the client alerting the client of one or more available value deals or offers the client has stored at the wallet service. Artificial intelligence may be used to match states with value data content based on any of or a mix of criterion. For example, if a client location check places the client in a known location associated to value data describing deals or offers also associated with that general location, the system may generate and send a notification to the client including the selected value deals or offers that the client could conveniently partake of. If the client has recent search data indication a hotel search, the system may send a notification alerting the client of a value deal or offer available under the “Travel Category” such as the 40 percent suite discount described earlier as a third-party offer.

If at step 1611, the wallet application determines not to send a notification based on results of state monitoring analysis against available value data then the process may move to step 1612 wherein the wallet application may determine if there are any value deals or offers set to expire. If at step 1612, the wallet application determines that there are one or more deals or offers set to expire, the service may generate and send a relevant notification to the client at step 1613 alerting the client of the value soon to expire. If at step 1612, there are no value deals or offers in danger of expiring the process may resolve back to step 1601. If at step 1611, the wallet service determines to send a notification including value data based on monitored state analysis against value data content, and then a relevant notification is sent to the client at step 1613.

In one embodiment, value data deals and offers may be uploaded by the client into the cloud wallet service wherein the client captured deals and offer codes from advertisement media other than during the process of receipt capture. For example, a client may receive a receipt with no value data but also be handed one or more coupons or other target advertising that include the scan able bar codes and or QR codes. The client may choose to add these deals/offers to the service and be alerted by the service at a later, or more convenient time that the values are available.

In one embodiment, a groceries chain membership card may be periodically uploaded into the cloud wallet service as value data to enable the service to track shopping points and any deals or offers put on the card as a POS service. Gas cards may also be periodically synced with the service to update and track fuel points and deals available through the card. Gift cards having monetary value may be uploaded as value data and notification of the gift card value may be sent whenever the client is near the merchant that the gift card might be used. Though a client may endeavor to consciously add value data to the service for management along with captured value data, the captured value data may represent data that would otherwise be lost or forgotten without the client being aware of that.

It will be apparent with skill in the art that the value code data capture, management, and notification system of the present invention may be provided using some or all the elements described herein. The arrangement of elements and functionality relative to the invention is described in different embodiments, each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A method for acquisition, aggregation, and management by a third party of value codes available to a client comprising:
(a) capturing to a network-capable computing device, one or more value codes defining value earned, awarded, or otherwise directed to a client through the process of transacting or another consumer activity;
(b) acquiring at the third-party location on a network the value codes captured in from the network-capable device;
(c) isolating the one or more value codes acquired in (b) and aggregating the value codes to a value data storage archive on behalf of the client;
(d) monitoring the location of consumer activity state of, and data generated by the client over time and comparing results against client value data content matching value code content data to client activity or data content by content relevancy;
(e) upon determination of content relevancy, selecting individual ones of the archived value codes and generating a notification for the client identifying the selected value codes available to the client for use in transacting or other consumer activities; and
(f) sending the notification to the client over the network, the notification containing, or at least providing immediate access to the value codes selected for use consideration by the client.

2. The method of claim 1, wherein the network is the Internet network including any sub-networks connected thereto.

3. The method of claim 1, wherein in (a) the network-capable computing device is a smart phone running a client wallet application that communicates with a parent application running on a server at the third-party network location and wherein the value codes are expressed as bar codes or quick response codes.

4. The method of claim 3, wherein in (a) the value codes are included in electronic receipts or on printed receipts captured using the camera function of the smart phone leveraged by the client application.

5. The method of claim 3, wherein in (a) the value code and receipt data are embedded in a quick response code captured to the smart phone.

6. The method of claim 1, wherein in (b) the value codes are sent to the third-party location from the network-capable device.

7. The method of claim 1, wherein in (b) the third-party location on the network is a cloud-based wallet service the client subscribes to.

8. The method of claim 4, wherein in (c) the value codes are isolated from receipt data.

9. The method of claim 5, wherein in (c) the value codes are isolated from quick response code receipt data.

10. The method of claim 1, wherein in (c) the value codes aggregated for storage are categorized under more than one category.

11. The method of claim 1, wherein in (d) monitoring is dependent on client activity as detected from the GPS location of the client's computing device, data generated by the client's computing device and or data stored representing client activity history stored by patronized merchant or by the wallet service account use history.

12. The method of claim 1, wherein in (d) the value data content is extracted or lifted from the value code to determine content relevancy.

13. The method of claim 1, wherein in (e) the value codes may be one or a combination of deals available at a shopping location or third-party offers redeemable at a third-party network location.

14. The method of claim 1, wherein in (f) the notifications are sent to the client's computing device over the network from the third-party location.

15. The method of claim 3 wherein in (f) the notifications are received at the smart phone wallet application with links to the actual bar codes or quick response codes wherein the wallet application enables download and display of the codes for use in transacting.

16. The method of claim 1, wherein in (f) the notifications are sent as a result of discovery of client location.

17. The method of claim 1, wherein in (f) the notifications are sent as a result of discovery of client search content.

18. The method of claim 1, wherein in (f) the notifications are sent as a result of discovery of client browser activity.

19. The method of claim 1, wherein in (f) the notifications are sent as a result of discovery of expiration time of the value codes arriving within a threshold window.

20. The method of claim 1, wherein in (a) the value codes are included in or otherwise associated with receipts captured through a client email account.
